(19) United States
(12) Patent Application Publication
(10) Pub. No.: US 2013/0126805 A1
(43) Pub. Date: May 23, 2013

(54) Method For Producing Alkylphosphonous Acid Salts

(71) Applicants: Michael Hill, Hamburg (DE); Werner Krause, Huerth (DE); Martin Sicken, Koeln (DE)

(72) Inventors: Michael Hill, Hamburg (DE); Werner Krause, Huerth (DE); Martin Sicken, Koeln (DE)

(73) Assignee: CLARIANT FINANCE (BVI) LIMITED, Tortola (VG)

(21) Appl. No.: 13/643,859

(22) PCT Filed: Apr. 20, 2011
(86) PCT No.: PCT/EP11/02015

§ 371 Date: Nov. 13, 2012

(30) Foreign Application Priority Data
Apr. 29, 2010 (DE) 10 2010 018 682.1

(51) Int. Cl. C07F 9/48; C09K 21/04

(52) U.S. Cl. CPC C07F 9/4816; C09K 21/04
USPC 252/607; 562/8; 556/174; 556/19; 252/609

(57) ABSTRACT

The invention relates to a method for producing alkylphosphonous acid salts, characterised in that a) a phosphinic acid source (I) is reacted with olefins (IV) in the presence of a catalyst A to obtain an alkylphosphonous acid, the salts or esters thereof (II), b) the thus obtained alkylphosphonous acid, the salts or esters thereof (II) are reacted with metal compounds of Mg, Ca, Al, Sb, Sn, Ge, Ti, Fe, Zr, Zn, Ce, Bi, Sr, Mn, Li, Na, K and/or a protoned nitrogen base to obtain the corresponding alkylphosphonous acid salts (III) of said metals and/or a nitrogen compound, wherein R¹, R², R³, R⁴ are the same or different and independently of each other represent H, C₁-C₁₈-alkyl, C₆-C₁₈-aryl, C₇-C₁₈-arylalkyl, C₇-C₁₈-alkylaryl and Y represents Mg, Ca, Al, Sb, Sn, Ge, Ti, Fe, Zr, Zn, Ce, Bi, Sr, Mn, Li, Na, K and/or a nitrogen compound and n represents ¼, ⅓, ½, 1 and the catalyst A is a transition metal and/or transition metal compound and/or catalyst systems which are composed of a transition metal and/or a transition metal compound and at least one ligand.

The invention relates to a process for preparing alkylphosphonous salts and to the use of the alkylphosphonous salts prepared by this process.

Salts of alkylphosphonous acids are known to be effective flame-retardant additives in polyesters (EP-A-0 794 189).

PCT/US2006/045770 describes flame-retardant thermoplastic polymers which comprise a mixture of metal salts of dialkylphosphinic acids and alkylphosphonous acids.

Alkylphosphonous acids can, according to the prior art, be prepared proceeding from phosphinic acids by free-radical addition of olefins, addition of Michael systems or the addition of alkyl halides only in a very inadequate manner or in a circuitous manner, for example via a protecting group route.

The preparation of alkylphosphonous acids with long-chain or aryl-substituted olefins is possible in the presence of transition metal catalysts, but an uneconomic excess of phosphorus-containing component is needed here (Montchamp, J.-L. et al., J. Am. Chem. Soc. 2002, 124, 9386-9387 and Org. Lett. 2004, 6, 3805-3808 and 2006, 8, 4169-4171; also J. Org. Chem. 2005, 70, 4064-4072).

A further synthesis route leads via the esters of the alkylphosphonous acids, which are themselves prepared from the corresponding phosphonous dihalides by reaction with alcohols. The phosphines and phosphonous dihalides used here are prepared in complex syntheses (Houben-Weyl, volume 12/1, p. 306). Some of the by-products formed here, and also some of the aforementioned starting materials, are toxic, pyrophoric and/or corrosive, i.e. highly undesirable and therefore to be avoided.

It is therefore an object of the invention to provide alkylphosphonous salts and processes for preparation thereof, in which the desired alkylphosphonous salts can be prepared in a particularly simple and economically viable manner and in correspondingly high yields. Especially alkylphosphonous salts with short side chains are to be preparable reproducibly without troublesome halogen compounds as reactants and with good yields. In addition, the starting materials and by-products of the novel process are not to be toxic, pyrophoric and corrosive.

This object is achieved by a process for preparing for preparing alkylphosphonous salts, which comprises

a) reacting a phosphinic acid source (I)

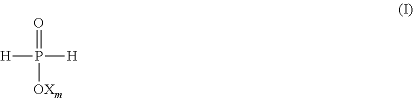

with olefins (IV)

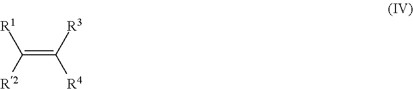

in the presence of a catalyst A to give an alkylphosphonous acid or salt or ester thereof (II)

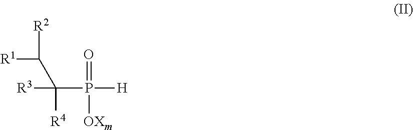

where R¹, R², R³, R⁴ are each independently H, C₁-C₁₈-alkyl, C₆-C₁₈-aryl, C₇⁻C₁₈-arylalkyl, C₇-C₁₈-alkylaryl and X is H, C₁-C₁₈-alkyl, C₆-C₁₈-aryl, C₇-C₁₈-arylalkyl, C₇-C₁₈-alkylaryl, C₂-C₁₈-alkenyl, (CH₂)ₖOH, CH₂—CHOH—CH₂OH, —(CH₂—CH₂O)ₖH or (CH₂—CH₂O)ₖ-alkyl, where k is an integer from 0 to 10, and/or X is H, Mg, Ca, Ba, Al, Pb, Fe, Zn, Mn, Ni, Li, Na, K and/or a protonated nitrogen base, where m is ⅓, ½, 1, and the catalyst A comprises transition metals and/or transition metal compounds and/or catalyst systems composed of a transition metal and/or a transition metal compound and at least one ligand, and

b) reacting the alkylphosphonous acid or salt or ester thereof (II) thus formed with metal compounds of Mg, Ca, Al, Sb, Sn, Ge, Ti, Fe, Zr, Zn, Ce, Bi, Sr, Mn, Li, Na, K and/or a protonated nitrogen base to give the corresponding alkylphosphonous salts (III) of these metals and/or a nitrogen compound

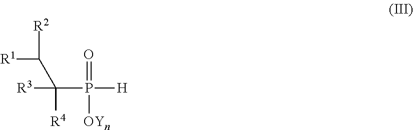

where R¹, R², R³, R⁴ are each as defined under a) and Y is Mg, Ca, Al, Sb, Sn, Ge, Ti, Fe, Zr, Zn, Ce, Bi, Sr, Mn, Li, Na, K and/or a nitrogen compound and n is ¼, ⅓, ½, 1.

Preferably, R¹, R², R³, R⁴ are the same or different and are each independently H, methyl, ethyl, n-propyl, isopropyl, n-butyl, isobutyl, tert-butyl and/or phenyl.

Preferably, the olefins (IV) are ethylene, propylene, n-butene and/or styrene.

Preferably, the phosphinic acid source (I) is phosphinic acid, or the sodium, potassium, calcium, magnesium, aluminum and/or ammonium salt and/or methyl, ethyl, propyl, i-propyl, butyl, t-butyl and/or glycol ester thereof.

Preferably, the transition metals and/or transition metal compounds are those from the seventh and eighth transition groups.

Preferably, the transition metals and/or transition metal compounds are rhodium, nickel, palladium, ruthenium and/or platinum.

Preferably, the alkylphosphonous salts (III) to be prepared are aluminum(III), calcium(II), magnesium(II), cerium(III), Ti(IV) and/or zinc(II) salts of ethyl-, propyl-, i-propyl-, butyl-, sec-butyl-, i-butyl-, 1-phenylethyl- and/or 2-phenylethylphosphonous acid.

Preferably, the inventive alkylphosphonous salts (III) obtained, based on the total weight of the mixture, comprise 0 to 5% by weight of further constituents such as alkylphosphonic salts and/or dialkylphosphinic salts.

The invention also relates to the use of alkylphosphonous salts (III) which have been prepared according to one or more of claims 1 to 8 as an alkylphosphonous acid-flame retardant combination comprising 0.5 to 99.5% by weight of alkylphosphonous salt and 0.5 to 99.5% by weight of at least one further flame retardant.

Suitable further flame retardants are, for example, dialkylphosphinic salts, aryl phosphates, phosphonates, salts of hypophosphorous acid and red phosphorus, brominated aromatic or cycloaliphatic hydrocarbons, phenols or ethers, chloroparaffin and hexachlorocyclopentadiene adducts.

In a particular embodiment, the inventive alkylphosphonous acid-flame retardant combination comprises 0.5 to 30% by weight of ethylphosphonous acid aluminum salt and 70 to 99.5% by weight of diethylphosphinic acid aluminum salt.

The invention also relates to the use of alkylphosphonous salts (III) which have been prepared according to one or more of claims 1 to 8 and alkylphosphonous salt-flame retardant combinations as claimed in one or more of claims 9 to 11 as a flame retardant or as an intermediate for preparation of flame retardants for thermoplastic polymers, for thermoset polymers, for clearcoats, for intumescent coatings, for wood and other cellulosic products, for production of flame-retardant polymer molding compositions, for production of flame-retardant polymer moldings and/or for rendering pure and blended polyester and cellulose fabrics flame-retardant by impregnation.

Preferably, the thermoplastic polymers are polyester, polystyrene and/or polyamide, and the thermoset polymers are unsaturated polyester resins, epoxy resins, polyurethanes and/or acrylates.

The invention further relates to a flame-retardant thermoplastic or thermoset polymer molding composition comprising 2 to 50% by weight of alkylphosphonous salts (III) which have been prepared according to one or more of claims 1 to 8 or alkylphosphonous salt-flame retardant combination as claimed in one or more of claims 9 to 11, based on the thermoplastic or thermoset polymer.

The invention additionally relates to flame-retardant thermoplastic or thermoset polymer moldings, films, filaments or fibers comprising 2 to 50% by weight of alkylphosphonous salts (III) which have been prepared according to one or more of claims 1 to 8 or alkylphosphonous salt-flame retardant combination as claimed in one or more of claims 9 to 11, based on the thermoplastic or thermoset polymer.

The flame-retardant thermoplastic or thermoset polymer moldings, films, filaments or fibers preferably comprise 3 to 40% by weight of alkylphosphonous salts (III) which have been prepared according to one or more of claims 1 to 8 or alkylphosphonous salt-flame retardant combination as claimed in one or more of claims 9 to 11, based on the thermoplastic or thermoset polymer.

The phosphinic acid source (I) preferably comprises phosphinic acid (hypophosphorous acid, H₃PO₂), a salt of phosphinic acid, an ester of phosphinic acid or mixtures thereof.

The salt of phosphinic acid (I) preferably comprises alkali metal salts, alkaline earth metal salts and/or ammonium salts.

The esters of phosphinic acid (I) are preferably alkyl, hydroxyalkyl, alkylaryl, aryl and/or alkenyl esters.

The esters of alkylphosphonous acid (II) are preferably the corresponding methyl, ethyl, propyl, i-propyl, butyl, t-butyl, glycol esters.

Y is preferably Mg, Ca, Al, Ti, Fe, Zr, Zn, Ce and/or a nitrogen compound. The catalyst system A is preferably formed by reaction of a transition metal and/or transition metal compound and at least one ligand.

When the phosphinic acid source (I) in step a) is phosphinic acid, an esterification can be conducted in order to obtain the ester (I) thereof.

When the phosphinic acid source (I) in step a) is a salt, an acidic hydrolysis can be conducted in order to obtain the free phosphinic acid (I).

When the compound (II) after step a) is an ester of alkylphosphonous acid, an acidic or basic hydrolysis can be conducted in order to obtain the free alkylphosphonous acid (II) or salt thereof.

When the compound (II) after step a) is a salt of alkylphosphonous acid, an acidic hydrolysis can be conducted in order to obtain the free alkylphosphonous acid (II).

Preferred sources used for the transition metals and transition metal compounds are the metal salts thereof; these include salts of mineral acids and organic salts, as known to those skilled in the art.

Suitable salts likewise include double salts and complex salts consisting of one or more transition metal ions and, independently, one or more alkali metal, alkaline earth metal, ammonium, organic ammonium, phosphonium and organic phosphonium ions and, independently, one or more abovementioned anions.

Preference is given to a source of the transition metals the transition metal as the element and/or a transition metal compound in the zero-valent state thereof.

The transition metal is preferably used in metallic form or as an alloy with further metals, preference being given here to boron, zirconium, tantalum, tungsten, rhenium, cobalt, iridium, nickel, palladium, platinum and/or gold. The transition metal content in the alloy used is preferably 45-99.95% by weight. The transition metal is preferably used in microdisperse form (particle size 0.1 mm-100 μm).

The transition metal is preferably used in supported form. Suitable support materials are metal oxides, metal carbonates, metal sulfates, metal phosphates, metal carbides, metal nitrides, metal aluminates, metal silicates, functionalized silicates or silica gels, functionalized polysiloxanes, charcoal, activated carbon, heteropolyanions, ion exchangers, functionalized polymers, polyethyleneimine/silicon dioxide and/or dendrimers.

Suitable sources of the metal salts and/or transition metals are preferably the complexes thereof. Suitable complexes of the metal salts and/or transition metals may be supported on the abovementioned support materials.

Preferably, the content of the supported transition metals mentioned is 0.01 to 20% by weight, preferably 0.1 to 10% by weight, especially 0.2 to 5% by weight, based on the total mass of the support material.

Suitable sources of transition metals and transition metal compounds are, for example, palladium, platinum, nickel, rhodium; palladium, platinum, nickel or rhodium on alumina, on silica, on charcoal, on activated carbon; palladium(II), nickel(II), platinum(II) or rhodium chloride, palladium(II), nickel(II), platinum(II) or rhodium bromide, palladium(II), nickel(II), platinum(II) or rhodium oxide, palladium(II), nickel(II), platinum(II) or rhodium sulfate, palladium(II), nickel(II), platinum(II) or rhodium nitrate, palladium(II), nickel(II), platinum(II) or rhodium hydroxide, palladium(II), nickel(II), platinum(II) or rhodium propionate, palladium(II), nickel(II), platinum(II) or rhodium acetate, palladium(II), nickel(II), platinum(II) or rhodium stearate, palladium(II), nickel(II), platinum(II) or rhodium 2-ethylhexanoate, palladium(II), nickel(II), platinum(II) or rhodium acetylacetonate, palladium(II), nickel(II), platinum(II) or rhodium hexafluoroacetylacetonate, palladium(II), nickel(II), platinum(II) or rhodium tetrafluoroborate, palladium(II), nickel(II), platinum(II) or rhodium trifluoroacetate, palladium(II), nickel(II), platinum(II) or rhodium methyl, palladium(II), nickel(II), platinum(II) or rhodium cyclopentadienyl, palladium(II), nickel(II), platinum(II) or rhodium methylcyclopentadienyl, -palladium(II), nickel(II), platinum(II) or rhodium pentamethylcyclopentadienyl, and the 1,4-bis(diphenylphosphino)butane, 1,3-bis(diphenylphosphino)propane, 1,2-bis(diphenylphosphino)ethane, 2-(2′-di-tert-butylphosphino)biphenyl, acetonitrile, benzonitrile, ethylenediamine, chloroform, 2-(dimethylaminomethyl)ferrocene, allyl, 2-methylallyl, bis(diphenylphosphino)butane, dimethylphenylphosphine, methyldiphenylphosphine, 1,5-cyclooctadiene, N,N,N′,N′-tetramethylethylenediamine, triphenylphosphine, tri-o-tolylphosphine, tricyclohexylphosphine, tributylphosphine, triethylphosphine, 2,2′-bis(diphenylphosphino)-1,1′-binaphthyl, 1,1′-bis(diphenylphosphino)ferrocene, N-methylimidazole, 2,2′-bipyridine, bicyclo[2.2.1]-hepta-2,5-diene, 2-methoxyethyl ether, ethylene glycol dimethyl ether, 1,2-dimethoxyethane, bis(N,N-diethylethylenediamine), 1,2-diaminocyclohexane, pyridine, ethylene and/or amine complexes thereof; (2-methylallyl)palladium(II) chloride dimer, bis(dibenzylideneacetone)palladium(0), tris(dibenzylideneacetone)dipalladium(0), tetrakis(triphenylphosphine)palladium(0), tetrakis(tricyclohexylphosphine)palladium(0), bis[1,2-bis(diphenylphosphino)ethane]palladium(0), bis(tri-tert-butylphosphine)palladium(0), tetrakis(methyldiphenylphosphine)palladium(0) and the chloroform complexes thereof; allylnickel(II) chloride dimer, bis(1,5-chlorobis(ethylene)rhodium dimer, hexarhodium hexadecacarbonyl, chloro(1,5-cyclooctadiene)rhodium dimer, chloro(norbornadiene)rhodium dimer, chloro(1,5-hexadiene)rhodium dimer.

The ligands are preferably phosphines of the formula (V)

PR⁵₃ (V)

in which the R⁵ radicals are each independently hydrogen, straight-chain, branched or cyclic C₁-C₂₀-alkyl, C₇-C₂₀-alkylaryl, C₁-C₂₀-carboxylate, C₁-C₂₀-alkoxy, C₂-C₂₀-alkoxycarbonyl, C₁-C₂₀-alkylthio, C₁-C₂₀-alkylsulfonyl, C₁-C₂₀-alkylsulfinyl, silyl and/or derivatives thereof and/or phenyl substituted by at least one R⁶ or naphthyl substituted by at least one R⁶. R⁶ is independently hydrogen, fluorine, chlorine, bromine, iodine, NH₂, nitro, hydroxyl, cyano, formyl, straight-chain, branched or cyclic C₁-C₂₀-alkyl, C₁-C₂₀-alkoxy, HN(C₁-C₂₀-alkyl), N(C₁-C₂₀-alkyl)₂, —CO₂—(C₁-C₂₀-alkyl), —CON(C₁-C₂₀-alkyl)₂, —OCO(C₁-C₂₀-alkyl), NHCO(C₁-C₂₀-alkyl), C₁-C₂₀-acyl, —SO₃M, —SO₂N(R⁷)M, —CO₂M, —PO₃M₂, —AsO₃M₂, —SiO₂M, —C(CF₃)₂OM (M=H, Li, Na or K), where R⁷ is hydrogen, fluorine, chlorine, bromine, iodine, straight-chain, branched or cyclic C₁-C₂₀-alkyl, C₁-C₂₀-carboxylate, C₁-C₂₀-alkoxy, C₂-C₂₀-alkoxycarbonyl, C₁-C₂₀-alkylthio, C₁-C₂₀-alkylsulfonyl, C₁-C₂₀-alkylsulfinyl, silyl and/or derivatives thereof, C₆-C₂₀-aryl, C₇-C₂₀-arylalkyl, C₇-C₂₀-alkylaryl, phenyl and/or biphenyl. Preferably, all R⁵ groups are identical.

Suitable phosphines (V) are, for example, trimethyl-, triethyl-, tripropyl-, tributyl-, tricyclohexyl-, triphenyl-, diphenylmethyl-, phenyldimethyl-, tri(o-tolyl)-, tri(p-tolyl)-, ethyldiphenyl-, dicyclohexylphenyl-, tri-(p-methoxyphenyl)phosphine, trimethyl phosphite and/or triphenyl phosphite; potassium, sodium and ammonium salts of diphenyl(2-sulfonatophenyl)phosphine, diphenyl(3-sulfonatophenyl)phosphine, bis(4,6-dimethyl-3-sulfonatophenyl)(2,4-dimethylphenyl)phosphine, bis(3-sulfonatophenyl)phenylphosphine, tris(4,6-dimethyl-3-sulfonatophenyl)phosphine, tris(2-sulfonatophenyl)phosphine, tris(3-sulfonatophenyl)phosphine, 2′-dicyclohexylphosphino-2,6-dimethoxy-3-sulfonato-1,1′-biphenyl.

The ligands are more preferably bidentate ligands of the general formula R⁵M-Z-M R⁵ (VI). In this formula, M is independently N, P, As or Sb. Preferably, the two M are the same, and M is more preferably a phosphorus atom. Each R⁵ group independently represents the radicals described under formula (V). Preferably, all R⁵ groups are identical. Z is preferably a bivalent bridging group comprising at least 1 bridge atom, preference being given to the presence of 2 to 6 bridge atoms.

Bridge atoms may be selected from C, N, O, Si and S atoms. Preferably, Z is an organic bridging group containing at least one carbon atom. Preferably, Z is an organic bridging group containing 1 to 6 bridge atoms, at least two of which are carbon atoms, which may be unsubstituted or substituted.

Preferred Z groups are —CH₂—, —CH₂—CH₂—, —CH₂—CH₂—CH₂—, —CH₂—CH(CH₃)—CH₂—, —CH₂—C(CH₃)₂—CH₂—, —CH₂—Si(CH₃)₂—CH₂—, —CH₂—O—CH₂—, —CH₂—CH₂—CH₂—CH₂—, unsubstituted or substituted 1,2-phenyl, 1,2-cyclohexyl, 1,1′- or 1,2-ferrocenyl radicals, 2,2′-(1,1′-biphenyl), 4,5-xanthene and/or oxydi-2,1-phenylene radicals.

Suitable bidentate phosphine ligands (VI) are, for example, 1,2-bis(dimethyl)-, 1,2-bis(diethyl)-, 1,2-bis(di-tert-butyl)-, 1,2-bis(dicyclohexyl)- and 1,2-bis(diphenylphosphino)ethane; 1,3-bis(dicyclohexyl)-, 1,3-bis(di-tert-butyl)- and 1,3-bis(diphenylphosphino)propane; 1,4-bis(diphenylphosphino)butane, 1,2-bis(di-tert-butyl)-, 1,2-bis(diphenyl)-, 1,2-bis(dicyclohexyl)-, 1,3-bis(di-tert-butyl), 1,3-bis(diphenyl)-, 1,3 bis(dicyclohexyl)benzene; 9,9-dimethyl-4,5-bis(diphenylphosphino)xanthene, 9,9-dimethyl-4,5-bis(diphenylphosphino)-2,7-di-tert-butylxanthene, 9,9-dimethyl-4,5-bis(di-tert-butylphosphino)xanthene, 1,1′-bis(diphenylphosphino)ferrocene, 2,2′-bis(diphenylphosphino)-1,1′-binaphthyl, 2,2′-bis(di-p-tolylphosphino)-1,1′-binaphthyl, (oxydi-2,1-phenylene)bis(diphenylphosphine), 2,2′-bis(di-tert-butylphosphino)-1,1′-biphenyl, 2,2′-bis(dicyclohexylphosphino)-1,1′-biphenyl, 2,2′-bis(diphenylphosphino)-1,1′-biphenyl; potassium, sodium and ammonium salts of 1,2-bis(di-4-sulfonatophenylphosphino)benzene, (2,2′-bis[[bis(3-sulfonatophenyl)phosphino]methyl]-4,4′,7,7′-tetrasulfonato-1,1′-binaphthyl, (2,2′-bis[[bis(3-sulfonatophenyl)phosphino]methyl]-5,5′-tetrasulfonato-1,1′-biphenyl, (2,2′-bis[[bis(3-sulfonatophenyl)phosphino]methyl]-1,1′-binaphthyl, (2,2′-bis[[bis(3-sulfonatophenyl)phosphino]methyl]-1,1′-biphenyl, 9,9-dimethyl-4,5-bis(diphenylphosphino)-2,7-sulfonatoxanthene, 9,9-dimethyl-4,5-bis(di-tert-butylphosphino)-2,7-sulfonatoxanthene, 1,2-bis(di-4-sulfonatophenylphosphino)benzene.

The ligands of the formula (V) and (VI) may be bound to a polymer or inorganic substrate by the R⁵ radicals and/or the bridging group.

The catalyst system has a transition metal/ligand molar ratio of 1:0.01 to 1:100, preferably of 1:0.05 to 1:10 and especially of 1:1 to 1:4.

The reactions in process stages a) and b) are preferably effected in a solvent or solvent system and in an atmosphere which comprises further gaseous constituents, for example nitrogen, oxygen argon, carbon dioxide; the temperature is −20 to 340° C., especially 20 to 180° C., and the total pressure from 1 to 100 bar.

Preferably, in process stage a), a phosphinic acid source (I) is converted to the corresponding alkylphosphonous acid, or the salt or ester (II) thereof.

Preferably, in process stage a), a phosphinic acid source (I) is converted to phosphinic acid (I) and this is converted to the corresponding alkylphosphonous acid (II).

Preferably, in process stage a), a phosphinic acid source (I) is converted to a phosphinic ester (I) and this is converted to the corresponding alkylphosphonous ester (II).

The products and/or component and/or transition metal and/or transition metal compound and/or catalyst system and/or ligand and/or reactants are isolated as desired after process stages a) and b), by distillation or rectification, by crystallization or precipitation, by filtration or centrifugation, by adsorption or chromatography, or other known methods.

Preferably, the reactions in process stages a) and b) are effected, as desired, in absorption columns, spray towers, bubble columns, stirred tanks, trickle bed reactors, flow tubes, loop reactors and/or kneaders.

Preferably, the reaction solutions/mixtures experience a mixing intensity corresponding to a rotational Reynolds number of 1 to 1 000 000, preferably of 100 to 100 000, and vigorous mixing of the respective reactants etc. is effected with an energy input of 0.080 to 10 kW/m³, preferably 0.30-1.65 kW/m³.

The catalyst A preferably acts homogeneously and/or heterogeneously during the reaction. Therefore, the heterogeneous catalyst in each case acts during the reaction as a suspension or bound to a solid phase.

Preference is given to effecting the respective reaction in a solvent as a monophasic system in a homogeneous or heterogeneous mixture and/or in the gas phase.

When a polyphasic system is used, it is additionally possible to use a phase transfer catalyst.

Suitable solvents for process stages a) and b) are water, alcohols, glycols, aliphatic hydrocarbons, aromatic hydrocarbons, halohydrocarbons, alicyclic hydrocarbons, ethers, glycol ethers, ketones, esters and/or carboxylic acids.

Suitable solvents are also the olefins and phosphinic acid sources used. These offer advantages in the form of a higher space-time yield.

Preference is given to performing the reaction under the autogenous vapor pressure of the olefin and/or of the solvent.

Preferably, R¹, R², R³, R⁴ in the olefin (IV) are the same or different and are each independently H, methyl, ethyl, n-propyl, isopropyl, n-butyl, isobutyl, tert-butyl and/or phenyl.

Preference is given to effecting the reaction at a partial pressure of the olefin of 0.01-100 bar, more preferably at a partial pressure of the olefin of 0.1-10 bar.

Preference is given to effecting the reaction in a phosphinic acid/olefin molar ratio of 1:10 000 to 1:0.001, more preferably in a ratio of 1:30 to 1:0.01.

Preference is given to effecting the reaction in a phosphinic acid/catalyst molar ratio of 1:1 to 1:0.00000001, more preferably at 1:0.01 to 1:0.000001.

Preference is given to effecting the reaction in a phosphinic acid/solvent molar ratio of 1:10 000 to 1:0, more preferably at 1:50 to 1:1.

In a process according to the invention for preparing compounds of the formula (II), a phosphinic acid source (I) is reacted with olefins in the presence of a catalyst and the product (II) (alkylphosphonous acid or salts, esters) is optionally freed of catalyst, transition metal or transition metal compound, ligand, complexing agent, salts, solvent, olefin, phosphinic acid, salts or esters thereof, and by-products.

The alkylphosphonous acid or salt or ester thereof (II) here may comprise, based on the total weight, 0 to 10% by weight of further phosphorus-containing constituents such as alkylphosphonic salts and/or dialkylphosphinic salts of the alkylphosphonous acid, or salt and/or ester thereof.

The alkylphosphonous acid or salt thereof (II) can be converted thereafter to further metal salts.

The metal compounds used in process stage b) are preferably compounds of the metals Mg, Ca, Al, Sb, Sn, Ge, Ti, Fe, Zr, Zn, Ce, Bi, Sr, Mn, Li, Na, K, more preferably Mg, Ca, Al, Ti, Zr, Zn, Sn, Ce, Fe.

Preferably, in process stage b), the alkylphosphonous acid or esters and/or alkali metal salts thereof (II) obtained after process stage a) are reacted with metal compounds of Mg, Ca, Al, Zn, Ti, Sn, Zr, Ce or Fe to give the alkylphosphonous salts (III) of these metals.

The reaction is effected in a molar ratio of alkylphosphonous acid/ester/salt (II) to metal of 8:1 to 1:3.

Preferably, the product mixture obtained after process stage a) is reacted with the metal compounds without further purification.

In a further embodiment of the process, the product mixture obtained after process stage a) is worked up.

Preference is given to working up the product mixture by isolating the alkylphosphonous acid or esters and/or alkali metal salts thereof (II).

Preference is given to effecting the isolation step by removing the solvent system, for example by evaporative concentration.

Preference is given to effecting the isolation step by removing the solvent system and the secondary components dissolved therein, for example by solid/liquid separation methods.

Preference is given to working up the product mixture by removing insoluble by-products, for example by solid/liquid separation methods.

Preference is given to conversion in process stage b) in a given solvent system which has been modified. For this purpose, acidic components, solubilizers, foam inhibitors etc. are added.

Preferably, alkylphosphonous ester/salt (II) obtained in process stage a) is converted to the corresponding alkylphosphonous acid (II) and reacted in process stage b) with metal compounds of Mg, Ca, Al, Zn, Ti, Sn, Zr, Ce or Fe to give the alkylphosphonous salts (III) of these metals.

Preferably, alkylphosphonous acid/ester (II) obtained in process stage a) is converted to an alkylphosphonous acid alkali metal salt (II) and reacted in process stage b) with metal compounds of Mg, Ca, Al, Zn, Ti, Sn, Zr, Ce or Fe to give the alkylphosphonous salts (III) of these metals.

The metal compounds of Mg, Ca, Al, Zn, Ti, Sn, Zr, Ce or Fe for process stage b) are preferably metals, metal oxides, hydroxides, oxide hydroxides, borates, carbonates, hydroxocarbonates, mixed hydroxocarbonates, phosphates, sulfates, hydroxosulfates, mixed hydroxosulfates, oxysulfates, acetates, nitrates, fluorides, chlorides, oxychlorides, bromides, iodides, carboxylic acid derivatives, for example acetate, formate, oxalate, tartrate, benzoate and/or alkoxides, for example n-propoxide, n-butoxide, tert-butoxide, isopropoxide, ethoxide and the hydrates thereof.

In the case of the aluminum compounds, preference is given to metallic aluminum and aluminum salts with anions of the seventh main group, for example aluminum fluoride, aluminum fluoride trihydrate, aluminum chloride (anhydrous, crystallized; anhydrous, sublimed), aluminum chloride hexahydrate, aluminum hydroxychloride, ALCHLOR®-AC from Hardman Australia, basic aluminum chloride solution, aluminum chloride solution, sulfate-conditioned polyaluminum chloride solution (PACS) from Lurgi Lifescience, OBRAFLOC 16® from Oker Chemie GmbH, alkaflock®, Ekocid® 60 products, Sachtoklar® products, Ekofloc® products, Ekozet products from Sachtleben, Locron®, Parimal® products from Clariant, anhydrous aluminum bromide, aluminum iodide, aluminum iodide hexahydrate.

Preference is given to aluminum salts with anions of the sixth main group, for example aluminum sulfide, aluminum selenide.

Preference is given to aluminum salts with anions of the fifth main group, for example aluminum phosphide, aluminum hypophosphite, aluminum antimonide, aluminum nitride, and aluminum salts with anions of the fourth main group, for example aluminum carbide, aluminum hexafluorosilicate; and likewise aluminum salts with anions of the first main group, for example aluminum hydride, aluminum calcium hydride, aluminum borohydride or else aluminum salts of the oxo acids of the seventh main group, for example aluminum chlorate.

Preference is given to aluminum salts of the oxo acids of the sixth main group, for example aluminum sulfate, aluminum sulfate hydrate, aluminum sulfate hexahydrate, aluminum sulfate hexadecasulfate, aluminum sulfate octadecasulfate, aluminum sulfate solution from Ekachemicals, aluminum sulfate liquid from Oker Chemie GmbH, sodium aluminum sulfate, sodium aluminum sulfate dodecahydrate, aluminum potassium sulfate, aluminum potassium sulfate dodecahydrate, aluminum ammonium sulfate, aluminum ammonium sulfate dodecahydrate, magaldrate (Al₅Mg₁₀(OH)₃₁(SO₄)₂×nH₂O).

Preference is also given to aluminum salts of the oxo acids of the fifth main group, for example aluminum nitrate nonahydrate, aluminum metaphosphate, aluminum phosphate, light aluminum phosphate hydrate, monobasic aluminum phosphate, monobasic aluminum phosphate solution; and likewise aluminum salts of the oxo acids of the fourth main group, for example aluminum silicate, aluminum magnesium silicate, aluminum magnesium silicate hydrate (almasilate), aluminum carbonate, hydrotalcite (Mg₆Al₂(OH)₁₆CO₃*nH₂O), dihydroxyaluminum sodium carbonate, NaAl(OH)₂CO₃ and aluminum salts of the oxo acids of the third main group, for example aluminum borate or else aluminum salts of the pseudohalides, for example aluminum thiocyanate.

Preference is given to aluminum oxide (purum, purissum, technical, basic, neutral, acidic), aluminum oxide hydrate, aluminum hydroxide or mixed aluminum oxide hydroxide and/or polyaluminum hydroxy compounds, which preferably have an aluminum content of 9 to 40% by weight.

Preferred aluminum salts are those with organic anions, for example aluminum salts of mono-, di-, oligo-, polycarboxylic acids, for example aluminum diacetate, aluminum acetate basic, aluminum subacetate, aluminum acetotartrate, aluminum formate, aluminum lactate, aluminum oxalate, aluminum tartrate, aluminum oleate, aluminum palmitate, aluminum monostearate, aluminum stearate, aluminum trifluoromethanesulfonate, aluminum benzoate, aluminum salicylate, aluminum hexaureasulfate triiodide, aluminum 8-oxyquinolate.

In the case of the zinc compounds, preference is given to elemental metallic zinc and zinc salts with inorganic anions, for example zinc halides (zinc fluoride, zinc fluoride tetrahydrate, zinc chloride (zinc butter), bromides zinc iodide).

Preference is given to zinc salts of the oxo acids of the third main group (zinc borate, e.g. Firebrake® ZB, Firebrake® 415, Firebrake® 500) and zinc salts of the oxo acids of the fourth main group ((basic) zinc carbonate, zinc hydroxide carbonate, anhydrous zinc carbonate, basic zinc carbonate hydrate, (basic) zinc silicate, zinc hexafluorosilicate, zinc hexafluorosilicate hexahydrate, zinc stannate, zinc hydroxide stannate, zinc magnesium aluminum hydroxide carbonate) and zinc salts of the oxo acids of the fifth main group (zinc nitrate, zinc nitrate hexahydrate, zinc nitrite, zinc phosphate, zinc pyrophosphate); and likewise zinc salts of the oxo acids of the sixth main group (zinc sulfate, zinc sulfate monohydrate, zinc sulfate heptahydrate) and zinc salts of the oxo acids of the seventh main group (hypohalites, halites, halates, e.g. zinc iodate, perhalates, e.g. zinc perchlorate).

Preference is given to zinc salts of the pseudohalides (zinc thiocyanate, zinc cyanate, zinc cyanide).

Preference is given to zinc oxides, zinc peroxides (e.g. zinc peroxide), zinc hydroxides or mixed zinc oxide hydroxides (standard zinc oxide, for example from Grillo, activated zinc oxide, for example from Rheinchemie, Zincit, Calamin®).

Preference is given to zinc salts of the oxo acids of the transition metals (zinc chromate(VI) hydroxide (zinc yellow), zinc chromite, zinc molybdate, e.g. Kemgard™ 911 B, zinc permanganate, zinc molybdate-magnesium silicate, e.g. Kemgard™ 911 C)

Preferred zinc salts are those with organic anions, which include zinc salts of mono-, di-, oligo-, polycarboxylic acids, salts of formic acid (zinc formates), of acetic acid (zinc acetates, zinc acetate dihydrate, galzin), of trifluoroacetic acid (zinc trifluoroacetate hydrate), zinc propionate, zinc butyrate, zinc valerate, zinc caprylate, zinc oleate, zinc stearate, of oxalic acid (zinc oxalate), of tartaric acid (zinc tartrate), citric acid (tribasic zinc citrate dihydrate), benzoic acid (benzoate), zinc salicylate, lactic acid (zinc lactate, zinc lactate trihydrate), acrylic acid, maleic acid, succinic acid, of amino acids (glycine), of acidic hydroxo functions (zinc phenoxide etc.), zinc para-phenolsulfonate, zinc para-phenolsulfonate hydrate, zinc acetylacetonate hydrate, zinc tannate, zinc dimethyldithiocarbamate, zinc trifluoromethanesulfonate.

Preference is given to zinc phosphide, zinc selenide, zinc telluride.

In the case of the titanium compounds is metallic titanium, as are titanium salts with inorganic anions, for example chloride, nitrate or sulfate ions, and organic anions, for example formate or acetate ions. Particular preference is given to titanium dichloride, titanium sesquisulfate, titanium(IV) bromide, titanium(IV) fluoride, titanium(III) chloride, titanium(IV) chloride, titanium(IV) chloride-tetrahydrofuran complex, titanium(IV) oxychloride, titanium(IV) oxychloride-hydrochloric acid solution, titanium(IV) oxysulfate, titanium(IV) oxysulfate-sulfuric acid solution, or else titanium oxides. Preferred titanium alkoxides are titanium(IV) n-propoxide (Tilcom® NPT, Vertec® NPT), titanium(IV) n-butoxide, titanium chloride triisopropoxide, titanium(IV) ethoxide, titanium(IV) 2-ethylhexyloxide (Tilcom® EHT, Vertetec® EHT)

In the case of the tin compounds, preference is given to metallic tin and tin salts (tin(II)chloride, tin(II) chloride dihydrate, tin(IV) chloride), and likewise to tin oxides and, as the preferred tin alkoxide, tin(IV) tert-butoxide.

In the case of the zirconium compounds, preference is given to metallic zirconium and zirconium salts such as zirconium(IV) chloride, zirconium sulfate, zirconium sulfate tetrahydrate, zirconyl acetate, zirconyl chloride, zirconyl chloride octahydrate. Preference is additionally given to zirconium oxides and, as the preferred zirconium alkoxide, zirconium(IV) tert-butoxide.

The metal compounds are preferably aluminum chloride, aluminum hydroxide, aluminum nitrate, aluminum sulfate, titanyl sulfate, titanium tetrabutoxide, zinc nitrate, zinc oxide, zinc hydroxide and/or zinc sulfate.

The metal compounds are preferably aluminum chloride, aluminum hydroxide, aluminum nitrate, aluminum sulfate, titanyl sulfate, titanium tetrabutoxide, zinc nitrate, zinc oxide, zinc hydroxide and/or zinc sulfate.

The reaction in process stage b) is effected at a solids content of the alkylphosphonous salts of 0.1 to 70% by weight, preferably 5 to 40% by weight.

Preference is given to effecting the reaction in process stage b) at a temperature of 20 to 250° C., preferably at a temperature of 80 to 120° C.

Preference is given to effecting the reaction in process stage b) at a pressure between 0.01 and 1000 bar, preferably 0.1 to 100 bar.

Preference is given to effecting the reaction in process stage b) over a reaction time of the alkylphosphonous acid (II) and/or alkali metal salts thereof with metal compounds of Mg, Ca, Al, Zn, Ti, Zr, Ce or Fe to give the alkylphosphonous salt (III) of these metals of 1*10⁻⁷ to 1*10² h.

Preferably, the alkylphosphonous salt (III) removed from the reaction mixture by filtration and/or centrifugation after process stage b) is dried.

Preferably, the alkylphosphonous salts (III) are removed in process stage b) with pressurized suction filters, vacuum suction filters, stirred suction filters, pressurized cartridge filters, axial leaf filters, circular leaf filters, centrifugal leaf filters, chamber/frame filter presses, automatic chamber filter presses, vacuum cellular drum filters, vacuum cellular disk filters, vacuum inside cell filters, vacuum pan filters, rotary pressure filters, vacuum belt filters.

Preferably, the filtration pressure is 5*10⁻⁶ to 60 bar, the filtration temperature 0 to 400° C., the specific filter performance 10 to 200 kg*h⁻¹*m⁻² and the residual moisture content of the resulting filtercake 5 to 60%.

Preferably, the alkylphosphonous salts (III) are removed in process stage b) with fully encased centrifuges such as overflow centrifuges, peeler centrifuges, chamber centrifuges, screw conveyor centrifuges, pan centrifuges, tube centrifuges, screen centrifuges such as overdriven and pendulum centrifuges, screen-conveyor centrifuges, screen-bowl centrifuges or pusher centrifuges.

The acceleration ratio is preferably 300 to 15 000, the suspension throughput 2 to 400 m³*h⁻¹, the solids throughput 5 to 80 t*h⁻¹ and the resulting moisture content of the resulting cake 5 to 60%.

Inventive apparatuses for the drying are chamber driers, channel driers, belt driers (air speed 2-3 m/s), pan driers (temperature 20 to 400° C.), drum driers (hot gas temperature 100-250° C.), paddle driers (temperature 50-300° C.), flow driers (air speed 10-60 m/s, air exhaust temperature 50-300° C.), fluidized bed driers (air speed 0.2-0.5 m/s, air exhaust temperature 50-300° C.), roller driers, tubular driers (temperature 20 to 200° C.), paddle driers, vacuum drying cabinets (temperature 20 to 300° C., pressure 0.001-0.016 MPa), vacuum roller driers (temperature 20 to 300° C., pressure 0.004-0.014 MPa, vacuum paddle driers (temperature 20 to 300° C., pressure 0.003-0.02 MPa), vacuum conical driers (temperature 20 to 300° C., pressure 0.003-0.02 MPa).

Preferably, the alkylphosphonous salt (III) of the metals Mg, Ca, Al, Zn, Ti, Sn, Zr, Ce or Fe, as desired, has a residual moisture content of 0.01 to 10% by weight, preferably of 0.1 to 1% by weight, a mean particle size of 0.1 to 2000 μm, preferably of 10 to 500 μm, a bulk density of 80 to 800 g/l, preferably of 200 to 700 g/l, a Pfrengle flowability of 0.5 to 10, preferably of 1 to 5.

The alkylphosphonous salt (III) of the metals Mg, Ca, Al, Zn, Ti, Sn, Zr, Ce or Fe here may comprise, based on the total weight, 0 to 5% by weight of further constituents such as alkylphosphonic salts and/or dialkylphosphinic salts of the metals Mg, Ca, Al, Zn, Ti, Sn, Zr, Ce or Fe.

The invention likewise relates to a solution of alkylphosphonous acid (II) and and/or esters and/or alkali metal salts thereof which comprises 10 to 99% by weight of alkylphosphonous acid (II) and/or esters and/or alkali metal or alkaline earth metal salts and 1 to 90% by weight of solvent, where the total is 100% by weight.

Preference is given to alkylphosphonous salts (III) of the metals Mg, Ca, Al, Zn, Sn, Ti, Ce, Zr or Fe which have been obtained by a process for preparing alkylphosphonous salts (III) in which

a) phosphinic acid and/or salts thereof are reacted with olefins in the presence of a catalyst A to give alkylphosphonous acid (II) and/or alkali metal or alkaline earth metal salts thereof in a solvent system and

b) the alkylphosphonous acid (II) and/or alkali metal or alkaline earth metal salts obtained after a) are reacted with metal compounds of Mg, Ca, Al, Zn, Sn, Ti, Ce, Zr or Fe to give alkylphosphonous salt (III) of these metals.

The present invention also provides, more particularly, a process in which sodium hypophosphite is reacted with ethylene in the presence of catalyst A in acetic acid to give the sodium salt of alkylphosphonous acid (II) as the main product, and this product is subsequently reacted with aluminum sulfate to give the aluminum salt of alkylphosphonous acid (III).

The present invention also provides, more particularly, a process in which phosphinic acid is reacted with ethylene in the presence of a catalyst A in water to give the alkylphosphonous acid (II) as the main product, and this product is subsequently reacted with aluminum hydroxide to give the aluminum salt of alkylphosphonous acid (III).

Preference is likewise given to alkylphosphonous acid (II) and/or alkali metal or alkaline earth metal salts thereof which have been obtained by reaction of phosphinic acid and/or salts thereof with olefins in the presence of a catalyst A to give mixtures of alkylphosphonous acid (II) and/or alkali metal salts thereof in a solvent system and subsequent conversion of the resulting alkylphosphonous acid (II) derivatives to the other compound group in each case, in order to arrive at a uniform product.

Preference is likewise given to alkylphosphonous salts (III) which have been obtained by reaction of

a) phosphinic acid and/or alkali metal or alkaline earth metal salts thereof with olefins in the presence of a catalyst A to give alkylphosphonous acid (II) and/or alkali metal or alkaline earth metal salts thereof in a solvent system and then

a1) conversion of the alkylphosphonous acid (II) derivatives obtained after a) to the other compound group in each case, in order to arrive at a uniform product, and then

b) reaction of the alkylphosphonous acid (II) derivatives obtained after a1) with metal compounds of Mg, Ca, Al, Zn, Sn, Ti, Ce, Zr or Fe to give the alkylphosphonous salts (III) of these metals.

Preference is likewise given to alkylphosphonous salts (II) which have been obtained by conversion of alkylphosphonous salts (II) obtained in process stage a) to the alkylphosphonous acid (II) and subsequent reaction of this alkylphosphonous acid (II) with metal compounds of Mg, Ca, Al, Zn, Sn, Ti, Ce, Zr or Fe to give the alkylphosphonous salts (III) of these metals.

The present invention also provides, more particularly, a process in which sodium hypophosphite is reacted with ethylene in the presence of a catalyst in acetic acid to give the sodium salt of alkylphosphonous acid (II) as the main product, and this product is subsequently reacted with sulfuric acid to give the alkylphosphonous acid (II) and with aluminum hydroxide to give the aluminum salt of the alkylphosphonous acid (III).

The present invention also provides, more particularly, a process in which phosphinic acid is reacted with ethylene in the presence of a catalyst in water to give the alkylphosphonous acid (II) as the main product, and this product is subsequently reacted with sodium hydroxide solution to give the sodium salt of alkylphosphonous acid (II) and with aluminum sulfate to give the aluminum salt of the alkylphosphonous acid (III).

Preference is likewise given to alkylphosphonous salts (III) which have been obtained by conversion of alkylphosphonous acid (II) obtained in process stage a) to an alkylphosphonous salt (II) and subsequent reaction of this alkylphosphonous salt (II) with metal compounds of Mg, Ca, Al, Zn, Sn, Ti, Ce, Zr or Fe to give the alkylphosphonous salts (III) of these metals.

The alkylphosphonous salts (III) prepared by the process according to the invention can be used especially as a flame retardant or as an intermediate for preparation of flame retardants, and an alkylphosphonous salt-flame retardant combination.

The inventive alkylphosphonous acid-flame retardant combination preferably comprises 0.5 to 99.5% by weight of alkylphosphonous salt and 0.5 to 99.5% by weight of at least one further flame retardant.

Particularly preferred salts of alkylphosphonous acid are aluminum, calcium and zinc salts of the C₁-C₆-alkylphosphonous acids.

Suitable further flame retardants are, for example, dialkylphosphinic salts, aryl phosphates, phosphonates, salts of hypophosphorous acid and red phosphorus, brominated aromatic or cycloaliphatic hydrocarbons, phenols or ethers, chloroparaffin, hexachlorocyclopentadiene adducts.

Particularly preferred salts of dialkylphosphinic acid are aluminum, calcium and zinc salts of the di-C₁-C₆-alkylphosphinic acids.

In a particular embodiment, the inventive alkylphosphonous acid-flame retardant combination comprises 0.5 to 99.5% by weight of ethylphosphonous acid aluminum salt and 0.5 to 99.5% by weight of diethylphosphinic acid aluminum salt.

In a particular embodiment, the inventive alkylphosphonous acid-flame retardant combination comprises 0.5 to 30% by weight of ethylphosphonous acid aluminum salt and 70 to 99.5% by weight of diethylphosphinic acid aluminum salt.

In addition, it is possible to add at least one synergist or phosphorus-nitrogen flame retardant to the flame-retardant thermoplastic or thermoset polymer molding composition or to the flame-retardant thermoplastic or thermoset polymer molding.

Preference is given to adding 0 to 40% by weight of synergist or phosphorus-nitrogen flame retardant to the flame-retardant thermoplastic or thermoset polymer molding composition or to the flame-retardant thermoplastic or thermoset polymer molding, based on the flame-retardant thermoplastic or thermoset polymer molding composition or the flame-retardant thermoplastic or thermoset polymer molding.

The synergists or phosphorus-nitrogen flame retardants are preferably condensation products of melamine and/or reaction products of melamine with phosphoric acid, and/or reaction products of condensation products of melamine with polyphosphoric acid and/or antimony oxide or mixtures thereof.

The synergist or phosphorus-nitrogen flame retardant is preferably melam, melem, melon, dimelamine pyrophosphate, melamine polyphosphate, melam polyphosphate, melon polyphosphate and melem polyphosphate, or mixed poly salts thereof.

The phosphorus-nitrogen flame retardants are preferably also nitrogen-containing phosphates of the formulae (NH₄)_{y}H_{3-y}PO₄ and (NH₄PO₃)_{z}, where y is 1 to 3 and z is 1 to 10 000.

These are preferably ammonium hydrogenphosphate, ammonium dihydrogenphosphate and/or ammonium polyphosphate.

The nitrogen-containing synergists are preferably also benzoguanamine, tris(hydroxyethyl)isocyanurate, allantoin, glycoluril, melamine, melamine cyanurate, dicyandiamide and/or guanidine.

Also in accordance with the invention are synergistic combinations of the phosphinates mentioned with nitrogen-containing compounds (DE-A-196 14 424, DE-A-197 34 437 and DE-A-197 37 727).

Suitable synergists also include carbodiimides, zinc borate, condensation products of melamine (WO-A-96/16948), condensation products of melamine with phosphoric acid or condensed phosphoric acids, or reaction products of condensation products of melamine with phosphoric acid or condensed phosphoric acids, and mixtures of the products mentioned (WO-A-98/39306).

In addition, it is possible to add at least one stabilizer to the flame-retardant thermoplastic or thermoset polymer molding composition or to the flame-retardant thermoplastic or thermoset polymer molding, for example zinc salts, basic or amphoteric oxides, hydroxides, carbonates, silicates, borates, stannates, mixed oxide-hydroxides, oxide-hydroxide-carbonates, hydroxide-silicates or hydroxide-borates, phosphonite, phosphite or a phosphonite/phosphite mixture, or an ester or a salt of long-chain aliphatic carboxylic acids (fatty acids), which typically have chain lengths of C₁₄ to C₄₀.

Preference is given to adding 0 to 15% by weight of stabilizer to the flame-retardant thermoplastic or thermoset polymer molding composition or to the flame-retardant thermoplastic or thermoset polymer molding, based on the flame-retardant thermoplastic or thermoset polymer molding composition or the flame-retardant thermoplastic or thermoset polymer molding.

This stabilizer is preferably magnesium oxide, calcium oxide, aluminum oxide, zinc oxide, manganese oxide, tin oxide, aluminum hydroxide, boehmite, dihydrotalcite, hydrocalumite, magnesium hydroxide, calcium hydroxide, zinc hydroxide, tin oxide hydrate, manganese hydroxide, zinc borate, basic zinc silicate and/or zinc stannate.

The stabilizers preferably comprise alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols such as ethylene glycol, glycerol, trimethylolpropane and/or pentaerythritol.

These stabilizers preferably comprise esters or salts of stearic acid, for example glyceryl monostearate or calcium stearate, or reaction products of montan wax acids with ethylene glycol, for example a mixture of ethylene glycol mono-montan wax ester, ethylene glycol di-montan wax ester, montan wax acids and ethylene glycol, or reaction products of montan wax acids with a calcium salt.

These reaction products are preferably a mixture of 1,3-butanediol mono-montan wax ester, 1,3-butanediol di-montan wax ester, montan wax acids, 1,3-butanediol, calcium montanate and the calcium salt.

It is possible to add further additives to the flame-retardant thermoplastic or thermoset polymer molding composition or to the flame-retardant thermoplastic or thermoset polymer molding, for example antioxidants, UV absorbers and light stabilizers, metal deactivators, peroxide-destroying compounds, polyamide stabilizers, basic co-stabilizers, nucleating agents and other additives.

Preference is given to adding 0 to 15% by weight of further additives to the flame-retardant thermoplastic or thermoset polymer molding composition or to the flame-retardant thermoplastic or thermoset polymer molding, based on the flame-retardant thermoplastic or thermoset polymer molding composition or the flame-retardant thermoplastic or thermoset polymer molding.

Suitable antioxidants are, for example, alkylated monophenols, e.g. 2,6-di-tert-butyl-4-methylphenol; 1,2-alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, δ-tocopherol and mixtures thereof (vitamin E); hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-di-methyl-4-hydroxyphenyl)disulfide; alkylidenebisphenols, e.g. 2,2′-methylenebis(6-tert-butyl-4-methylphenol); O-, N- and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzyl aromatics, e.g. 1,3,5-tris-(3,5-di-tert-butyl)-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris-(3,5-di-tert-butyl-4-hydroxybenzyl)phenol; triazine compounds, e.g. 2,4-bisoctylmercapto-6-(3,5-di-tert-butyl-4-hydroxyanilino)-1,3,5-triazine; benzyl phosphonates, e.g. dimethyl 2,5-di-tert-butyl-4-hydroxybenzylphosphonate; acylaminophenols, 4-hydroxylauramide, 4-hydroxystearanilide, N-(3,5-di-tert-butyl-4-hydroxyphenyl)carbamic acid octyl ester; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Suitable UV absorbers and light stabilizers are, for example, 2-(2′-hydroxyphenyl)benzotriazoles, for example 2-(2′-hydroxy-5′-methylphenyl)benzotriazole;

2-hydroxybenzophenones, for example the 4-hydroxy, 4-methoxy, 4-octoxy, 4-decyloxy, 4-dodecyloxy, 4-benzyloxy, 4,2′,4-trihydroxy, 2′-hydroxy-4,4′-dimethoxy derivative;

esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; acrylates, for example ethyl or isooctyl α-cyano-β,β-diphenylacrylate, methyl α-carbomethoxycinnamate, methyl or butyl α-cyano-β-methyl-p-methoxycinnamate, methyl α-carbomethoxy-p-methoxycinnamante, N-(β-carbomethoxy-β-cyanovinyl)-2-methylindoline.

In addition, nickel compounds, for example nickel complexes of 2,2′-thiobis-[4(1,1,3,3-tetramethylbutyl)phenol], such as the 1:1 or the 1:2 complex, optionally with additional ligands such as n-butylamine, triethanolamine or N-cyclohexyldiethanolamine, nickel dibutyldithiocarbamate, nickel salts of 4-hydroxy-3,5-di-tert-butylbenzylphosphonic acid monoalkyl esters, such as those of the methyl or ethyl ester, nickel complexes of ketoximes, such as those of 2-Hydroxy-4-methylphenyl undecyl ketoxime, nickel complexes of 1-phenyl-4-lauroyl-5-hydroxy-pyrazole, optionally with additional ligands; sterically hindered amines, for example bis(2,2,6,6-tetramethylpiperidyl)sebacate; oxalamides, for example 4,4′-dioctyloxyoxanilide; 2-(2-hydroxyphenyl)-1,3,5-triazines, for example 2,4,6-tris(2-hydroxy-4-octyloxyphenyl)-1,3,5-triazine.

Suitable metal deactivators are, for example, N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalic dihydrazide, oxanilide, isophthalic dihydrazide, sebacic bisphenylhydrazide, N,N′-diacetyladipic dihydrazide, N,N′-bis(salicyloyl)oxalic dihydrazide, N,N′-bis(salicyloyl)thiopropionic dihydrazide.

Suitable peroxide-destroying compounds are, for example, esters of β-thiodipropionic acid (lauryl, stearyl, myristyl or tridecyl esters), mercaptobenzimidazole, the zinc salt of 2-mercaptobenzimidazole, zinc dibutyldithiocarbamate, dioctadecyl disulfide, pentaerythrityl tetrakis(β-dodecylmercapto)propionate.

Suitable basic co-stabilizers are melamine, polyvinylpyrrolidone, dicyandiamide, triallyl cyanurate, urea derivatives, hydrazine derivatives, amines, polyamides, polyurethanes, alkali metal and alkaline earth metal salts of higher fatty acids, for example calcium stearate, zinc stearate, magnesium behenate, magnesium stearate, sodium ricinoleate, potassium palmitate, antimony catecholate or tin catecholate.

Suitable nucleating agents are, for example, 4-tert-butylbenzoic acid, adipic acid and diphenylacetic acid.

The other additives include, for example, plasticizers, expandable graphite, lubricants, emulsifiers, pigments, optical brighteners, antistats, blowing agents, heat stabilizers, impact modifiers, processing aids, antidripping agents, compatibilizers, nucleating agents, additives for laser marking, hydrolysis stabilizers, chain extenders and/or plasticizing agents.

It is possible to add further fillers and reinforcers to the flame-retardant thermoplastic or thermoset polymer molding composition or to the flame-retardant thermoplastic or thermoset polymer molding. Examples of fillers and reinforcers include calcium carbonate, silicates, glass fibers, asbestos, talc, kaolin, mica, barium sulfate, metal oxides and hydroxides, carbon black, graphite and others.

Preference is given to adding 0 to 70% by weight of filler and/or reinforcers to the flame-retardant thermoplastic or thermoset polymer molding composition or to the flame-retardant thermoplastic or thermoset polymer molding, based on the flame-retardant thermoplastic or thermoset polymer molding composition or the flame-retardant thermoplastic or thermoset polymer molding.

The metal oxides are preferably magnesium oxide, calcium oxide, aluminum oxide, zinc oxide, manganese oxide and/or tin oxide.

The hydroxides are preferably aluminum hydroxide, boehmite, magnesium hydroxide, hydrotalcite, hydrocalumite, calcium hydroxide, zinc hydroxide, tin oxide hydrate and/or manganese hydroxide.

The flame-retardant thermoplastic or thermoset polymer molding compositions and moldings preferably comprise 50 to 98% by weight of polymer, 2 to 50% by weight of alkylphosphonous salt (III) or alkyiphosphonous acid-flame retardant combination, 0 to 40% by weight of synergists, 0 to 15% by weight of stabilizers, 0 to 15% by weight of further additives and 0 to 60% by weight of fillers.

The flame-retardant thermoplastic or thermoset polymer molding compositions and moldings preferably comprise 70 to 97% by weight of polymer, 3 to 30% by weight of alkylphosphonous salt (III) or alkylphosphonous acid-flame retardant combination, 0 to 10% by weight of synergists, 0 to 5% by weight of stabilizers, 0 to 5% by weight of further additives and 0 to 60% by weight of fillers.

The flame-retardant thermoplastic or thermoset polymer molding compositions and moldings preferably comprise 20 to 67% by weight of polymer, 3 to 20% by weight of alkylphosphonous salt (III) or alkylphosphonous acid-flame retardant combination, 0 to 10% by weight of synergists, 0 to 3% by weight of stabilizers, 0 to 3% by weight of further additives and 30 to 60% by weight of fillers.

The flame-retardant thermoplastic or thermoset polymer molding compositions and moldings preferably comprise 20 to 67% by weight of polymer, 5 to 10.5% by weight of alkyiphosphonous salt (III) or alkyiphosphonous acid-flame retardant combination, 0.1 to 8% by weight of synergists, 0.1 to 1% by weight of stabilizers, 0.1 to 1.5% by weight of further additives and 30 to 60% by weight of fillers.

The flame-retardant thermoplastic or thermoset polymer molding compositions and moldings preferably comprise 40 to 96.9% by weight of polymer, 3 to 30% by weight of alkylphosphonous salt (III) or alkylphosphonous acid-flame retardant combination, 0 to 10% by weight of synergists, 0 to 3% by weight of stabilizers, 0 to 3% by weight of further additives and 0.1 to 30% by weight of fillers.

The flame-retardant thermoplastic or thermoset polymer molding compositions and moldings preferably comprise 40 to 67% by weight of polymer, 5 to 17.5% by weight of alkylphosphonous salt (III) or alkylphosphonous acid-flame retardant combination, 0.1 to 10% by weight of synergists, 0.1 to 1% by weight of stabilizers, 0.1 to 1.5% by weight of further additives and 0.1 to 30% by weight of fillers.

These additional synergists, phosphorus-nitrogen flame retardants, stabilizers, further additives and fillers can be added to the polymers before, together with or after addition of the alkylphosphonous salt or of the alkylphosphonous acid-flame retardant combination. The metered addition of these synergists, phosphorus-nitrogen flame retardants, stabilizers, further additives and fillers, and also of the flame retardant, can be effected in solid form, in a solution or melt, or else in the form of solid or liquid mixtures or as masterbatches/concentrates.

The aforementioned synergists, phosphorus-nitrogen flame retardants, stabilizers, further additives, fillers and alkylphosphonous salts or alkylphosphonous acid-flame retardant combinations can be introduced into the polymer in a wide variety of different process steps. For instance, it is possible in the case of polyamides or polyesters, at the start or at the end of the polymerization/polycondensation or in a subsequent compounding operation, to mix the synergists, phosphorus-nitrogen flame retardant, stabilizers, further additives, fillers and alkylphosphonous salt or the alkylphosphonous acid-flame retardant combination into the polymer melt. In addition, there are processing operations in which the synergists, phosphorus-nitrogen flame retardants, stabilizers, further additives, fillers and alkylphosphonous salt or alkylphosphonous acid-flame retardant combination are not added until a later stage. This is practiced especially in the case of use of pigment or additive masterbatches. There is also the possibility of applying synergists, phosphorus-nitrogen flame retardants, stabilizers, further additives, fillers and alkylphosphonous salt or alkylphosphonous acid-flame retardant combination, particularly in pulverulent form, to the polymer pellets, which may be warm as a result of the drying operation, by drum application.

The alkylphosphonous salt-flame retardant combination is preferably in the form of pellets, flakes, fine grains, powder and/or micronizate.

The alkylphosphonous salt-flame retardant combination is preferably in the form of a physical mixture of the solids, of a melt mixture, of a compactate, of an extrudate, or in the form of a masterbatch.

Suitable polyesters derive from dicarboxylic acids and esters thereof and diols and/or from hydroxycarboxylic acids or the corresponding lactones. Particular preference is given to using terephthalic acid and ethylene glycol, propane-1,3-diol and butane-1,3-diol.

Suitable polyesters include polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and block polyether esters which derive from polyethers with hydroxyl end groups; and also polyesters modified with polycarbonates or MBS.

Preference is given to producing the molding composition proceeding from the free dicarboxylic acid and diols, first by direct esterification and then polycondensation.

Preference is given to polycondensation proceeding from dicarboxylic esters, especially dimethyl esters, first by transesterification and then polycondensation using the catalysts customary therefor.

In the course of polyester preparation, it is possible with preference to add not only the standard catalysts but also customary additives (crosslinking agents, matting agents and stabilizers, nucleating agents, dyes and fillers etc.).

The esterification and/or transesterification in the course of polyester preparation preferably takes place at temperatures of 100-300° C., more preferably at 150-250° C.

The polycondensation in the course of polyester preparation preferably takes place at pressures between 0.1 to 1.5 mbar and temperatures of 150-450° C., more preferably at 200-300° C.

The flame-retardant polyester molding compositions prepared in accordance with the invention are preferably used in polyester moldings.

Preferred polyester moldings are filaments, fibers, films and moldings, which comprise mainly terephthalic acid as the dicarboxylic acid component and mainly ethylene glycol as the diol component.

Preferably, the resulting phosphorus content in filaments and fibers produced from flame-retardant polyester is 0.1-18%, preferably 0.5-15%, and, in the case of films, 0.2-15%, preferably 0.9-12% by weight.

Suitable polystyrenes are polystyrene, poly(p-methylstyrene) and/or poly(alpha-methylstyrene).

The suitable polystyrenes are preferably copolymers of styrene or alpha-methylstyrene with dienes or acrylic derivatives, for example styrene-butadiene, styrene-acrylonitrile, styrene-alkyl methacrylate, styrene-butadiene-alkyl acrylate and methacrylate, styrene-maleic anhydride, styrene-acrylonitrile-methyl acrylate; more impact-resistant mixtures of styrene copolymers and another polymer, for example a polyacrylate, a diene polymer or an ethylene-propylene-diene terpolymer; and block copolymers of styrene, for example styrene-butadiene-styrene, styrene-isoprene-styrene, styrene-ethylene/butylene-styrene or styrene-ethylene/propylene-styrene.

The suitable polystyrenes are preferably also graft copolymers of styrene or alpha-methylstyrene, for example styrene onto polybutadiene, styrene onto polybutadiene-styrene or polybutadiene-acrylonitrile copolymers, styrene and acrylonitrile (or methacrylonitrile) onto polybutadiene; styrene, acrylonitrile and methyl methacrylate onto polybutadiene; styrene and maleic anhydride onto polybutadiene; styrene, acrylonitrile and maleic anhydride or maleimide onto polybutadiene; styrene and maleimide onto polybutadiene, styrene and alkyl acrylates or alkyl methacrylates onto polybutadiene, styrene and acrylonitrile onto ethylene-propylene-diene terpolymers, styrene and acrylonitrile onto polyalkyl acrylates or polyalkyl methacrylates, styrene and acrylonitrile onto acrylate-butadiene copolymers, and mixtures thereof, as known, for example, as what are called ABS, MBS, ASA or AES polymers.

The polymers are preferably polyamides and copolyamides which derive from diamines and dicarboxylic acids and/or from aminocarboxylic acids or the corresponding lactams, such as nylon-2,12, nylon-4, nylon-4,6, nylon-6, nylon-6,6, nylon-6,9, nylon-6,10, nylon-6,12, nylon-6,66, nylon-7,7, nylon-8,8, nylon-9,9, nylon-10,9, nylon-10,10, nylon-11, nylon-12, etc. These are known, for example, by the trade names Nylon®, from DuPont, Ultramid®, from BASF, Akulon® K122, from DSM, ®Zytel 7301, from DuPont; Durethan® B 29, from Bayer and Grillamid®, from Ems Chemie.

Also suitable are aromatic polyamides proceeding from m-xylene, diamine and adipic acid; polyamides prepared from hexamethylenediamine and iso- and/or terephthalic acid and optionally an elastomer as a modifier, for example poly-2,4,4-trimethylhexamethyleneterephthalamide or poly-m-phenyleneisophthalamide, block copolymers of the aforementioned polyamides with polyolefins, olefin copolymers, ionomers or chemically bound or grafted elastomers, or with polyethers, for example with polyethylene glycol, polypropylene glycol or polytetramethylene glycol. In addition, EPDM- or ABS-modified polyamides or copolyamides; and polyamides condensed during processing (“RIM polyamide systems”).

The alkylphosphonous salts (III), prepared according to one or more of claims 1 to 8, or the alkylphosphonous acid-flame retardant combination are preferably used in molding compositions which go on to be used for production of polymer moldings.

The invention also relates to alkylphosphonous salt-flame retardant combinations which comprise alkylphosphonous salts (III) which have been prepared according to one or more of claims 1 to 8.

The invention additionally relates to polymer molding compositions and to polymer moldings, films, filaments and fibers comprising the mixtures, produced in accordance with the invention, of alkylphosphonous salt (III) and dialkylphosphinic salt of the metals Mg, Ca, Al, Zn, Ti, Sn, Zr, Ce or Fe.

The invention finally also relates to a process for producing flame-retardant polymer moldings, wherein inventive flame-retardant polymer molding compositions are processed by injection molding (for example injection molding machine of the Aarburg Allrounder type) and pressing, foam injection molding, internal gas pressure injection molding, blow molding, film casting, calendering, laminating or coating at elevated temperatures to give the flame-retardant polymer molding.

Preferably, the thermoset polymers comprise unsaturated polyester resins (UP resins) which derive from copolyesters of saturated and unsaturated dicarboxylic acids or anhydrides thereof with polyhydric alcohols, and vinyl compounds as crosslinking agents. UP resins are cured by free-radical polymerization with initiators (e.g. peroxides) and accelerators.

Preferred unsaturated dicarboxylic acids and derivatives for preparation of the polyester resins are maleic anhydride and fumaric acid.

Preferred saturated dicarboxylic acids are phthalic acid, isophthalic acid, terephthalic acid, tetrahydrophthalic acid, adipic acid.

Preferred diols are 1,2-propanediol, ethylene glycol, diethylene glycol and neopentyl glycol, neopentyl glycol, ethoxylated or propoxylated bisphenol A.

A preferred vinyl compound for crosslinking is styrene.

Preferred curative systems are peroxides and metal coinitiators, for example hydroperoxides and cobalt octanoate and/or benzoyl peroxide and aromatic amines and/or UV light and photosensitizers, e.g. benzoin ethers.

Preferred hydroperoxides are di-tert-butyl peroxide, tert-butyl peroctoate, tert-butyl perpivalate, tert-butyl per-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxodicarbonate.

Preferably, initiators are used in amounts of 0.1 to 20% by weight, preferably 0.2 to 15% by weight, based on the mass of all comonomers.

Preferred metal coinitiators are compounds of cobalt, manganese, iron, vanadium, nickel or lead. Preferably, metal coinitiators are used in amounts of 0.05 to 1% by weight, based on the mass of all comonomers.

Preferred aromatic amines are dimethylaniline, dimethyl-p-toluene, diethylaniline and phenyldiethanolamine.

In one process for preparing flame-retardant copolymers, at least one ethylenically unsaturated dicarboxylic anhydride derived from at least one C₄-C₈-dicarboxylic acid, at least one vinylaromatic compound and a polyol are copolymerized, and reacted with inventive adducts of alkylphosphonous acid derivatives and diester-forming olefins.

In one process for producing flame-retardant thermoset compositions, a thermoset resin is mixed with inventive alkylphosphonous salt or the alkylphosphonous acid-flame retardant combination and further synergists, stabilizers, further additives and fillers or reinforcers, and the resulting mixture is wet pressed at pressures of 3 to 10 bar and temperatures of 20 to 60° C. (cold pressing).

In a further process for producing flame-retardant thermoset compositions, a thermoset resin is mixed with inventive alkylphosphonous salt or the alkylphosphonous acid-flame retardant combination and further synergists, stabilizers, further additives and fillers or reinforcers, and the resulting mixture is wet pressed at pressures of 3 to 10 bar and temperatures of 80 to 150° C. (warm or hot pressing).

Preferably, the polymers are crosslinked epoxy resins which derive from aliphatic, cycloaliphatic, heterocyclic or aromatic glycidyl compounds, for example from bisphenol A diglycidyl ethers, bisphenol F diglycidyl ethers, which are crosslinked by means of customary hardeners and/or accelerators.

Suitable glycidyl compounds are bisphenol A diglycidyl esters, bisphenol F diglycidyl esters, polyglycidyl esters of phenol formaldehyde resins and cresol-formaldehyde resins, polyglycidyl esters of phthalic acid, isophthalic acid and terephthalic acid, and of trimellitic acid, N-glycidyl compounds of aromatic amines and heterocyclic nitrogen bases, and di- and polyglycidyl compounds of polyhydric aliphatic alcohols.

Suitable hardeners are aliphatic, cycloaliphatic, aromatic and heterocyclic amines or polyamines, such as ethylenediamine, diethylenetriamine triethylenetetramine, propane-1,3-diamine, hexamethylenediamine, aminoethylpiperazine, isophoronediamine, polyamidoamine, diaminodiphenylmethane, diaminodiphenyl ether, diaminodiphenyl sulfone, aniline-formaldehyde resins, 2,2,4-trimethylhexane-1,6-diamine, m-xylylenediamine, bis(4-aminocyclohexyl)methane, 2,2-bis(4-aminocyclohexyl)propane, 3-aminomethyl-3,5,5-trimethylcyclohexylamine (isophoronediamine), polyamidoamines, cyanoguanidine and dicyandiamide, and likewise polybasic acids or anhydrides thereof, for example phthalic anhydride, maleic anhydride, tetrahydrophthalic anhydride, methyltetrahydrophthalic anhydride, hexahydrophthalic anhydride and methylhexahydrophthalic anhydride, and also phenols, for example phenol-novolac resin, cresol-novolac resin, dicyclopentadiene-phenol adduct resin, phenol aralkyl resin, cresolaralkyl resin, naphtholaralkyl resin, biphenol-modified phenolaralkyl resin, phenol-trimethylolmethane resin, tetraphenylolethane resin, naphthol-novolac resin, naphthol-phenol cocondensate resin, naphthol-cresol cocondensate resin, biphenol-modified phenol resin and aminotriazine-modified phenol resin. All hardeners can be used alone or in combination with one another.

Suitable catalysts or accelerators for the crosslinking in the polymerization are tertiary amines, benzyldimethylamine, N-alkylpyridines, imidazole, 1-methylimidazole, 2-methylimidazole, 2-ethyl-4-methylimidazole, 2-ethyl-4-methylimidazole, 2-phenylimidazole, 2-heptadecylimidazole, metal salts of organic acids, Lewis acids and amine complex salts.

The formulation of the invention may also comprise other additives which are commonly used in epoxy resin formulations, such as pigments, dyes and stabilizers.

Epoxy resins are suitable for potting of electrical or electronic components and for saturation and impregnation processes. In electrical engineering, epoxy resins are predominantly rendered flame-retardant and used for printed circuit boards and insulators.

Preferably, the polymers are crosslinked polymers which derive from aldehydes on the one hand, and phenols, urea or melamine on the other hand, such as phenol-formaldehyde, urea-formaldehyde and melamine-formaldehyde resins. The polymers preferably comprise crosslinkable acrylic resins which derive from substituted acrylic esters, for example from epoxy acrylates, urethane acrylates or polyester acrylates.

Preferably, the polymers are alkyd resins, polyester resins and acrylate resins which have been crosslinked with melamine resins, urea resins, isocyanates, isocyanurates, polyisocyanates or epoxy resins.

Preferred polyols are alkene oxide adducts of ethylene glycol, 1,2-propanediol, bisphenol A, trimethylolpropane, glycerol, pentaerythritol, sorbitol, sugars, degraded starch, ethylenediamine, diaminotoluene and/or aniline, which serve as initiators. The preferred alkoxylating agents preferably contain 2 to 4 carbon atoms, particular preference being given to ethylene oxide and propylene oxide.

Preferred polyester polyols are obtained by polycondensation of a polyalcohol such as ethylene glycol, diethylene glycol, propylene glycol, 1,4-butanediol, 1,5-pentanediol, methylpentanediol, 1,6-hexanediol, trimethylolpropane, glycerol, pentaerythritol, diglycerol, glucose and/or sorbitol, with a dibasic acid such as oxalic acid, malonic acid, succinic acid, tartaric acid, adipic acid, sebacic acid, maleic acid, fumaric acid, phthalic acid and/or terephthalic acid. These polyester polyols can be used alone or in combination.

Suitable polyisocyanates are aromatic, acyclic or aliphatic polyisocyanates having not fewer than two isocyanate groups and mixtures thereof. Preference is given to aromatic polyisocyanates such as tolyl diisocyanate, methylene diphenyl diisocyanate, naphthylene diisocyanate, xylylene diisocyanate, tris(4-isocyanatophenyl)methane and polymethylenepolyphenylene diisocyanates; alicyclic polyisocyanates such as methylenediphenyl diisocyanate, tolyl diisocyanate; aliphatic polyisocyanates and hexamethylene diisocyanate, isophorone diisocyanate, dimeryl diisocyanate, 1,1-methylenebis(4-isocyanatocyclohexane-4,4′-diisocyanatodicyclohexylmethane isomer mixture, 1,4-cyclohexyl diisocyanate, Desmodur® products (Bayer) and lysine diisocyanate and mixtures thereof.

Suitable polyisocyanates are modified products which are obtained by reaction of polyisocyanate with polyol, urea, carbodiimide and/or biuret.

Suitable catalysts for preparation of polyurethane are strong bases, alkali metal salts of carboxylic acids or aliphatic tertiary amines. Preference is given to quaternary ammonium hydroxide, alkali metal hydroxide or alkoxide, sodium acetate or potassium acetate, potassium octoate, sodium benzoate, 1,4-diazabicyclo[2.2.2]octane, N,N,N′,N′-tetramethylhexamethylenediamine, N,N,N′,N′-tetramethylpropylenediamine, N,N,N′,N′,N″-pentamethyldiethylenetriamine, N,N′-di(C₁-C₂)-alkylpiperazine, trimethylaminoethylpiperazine, N,N-dimethylcyclohexylamine, N,N-dimethylbenzylamine, N-methylmorpholine, N-ethylmorpholine, trimethylamine, triethylamine, tributylamine, triethylenediamine, bis(dimethylaminoalkyl)piperazines, N,N,N′,N′-tetramethylethylenediamine, N,N-diethylbenzylamine, bis(N,N-diethylaminoethyl)adipate, N,N,N′,N′-tetramethyl-1,3-butanediamine, N,N-diethyl-[beta]-phenylethylamine, 1,2-dimethylimidazole, 2-methylimidazole etc. Preferably, the weight ratio of the polyisocyanate to polyol is 170 to 70, preferably 130 to 80, based on 100 parts by weight of the polyol.

Preferably, the weight ratio of the catalyst is 0.1 to 4 parts by weight, more preferably 1 to 2 parts by weight, based on 100 parts by weight of the polyol.

Preferred blowing agents for polyurethanes are water, hydrocarbons, hydrochlorofluorocarbon, hydrofluorocarbon etc. The amount of the blowing agent for polyurethanes is 0.1 to 1.8 parts by weight, preferably 0.3 to 1.6 parts by weight and especially 0.8 to 1.6 parts by weight, based on 100 parts by weight of the polyol.

The invention is illustrated by the examples which follow.

Chemicals and Abbreviations Used

Deloxan® THP metal scavenger (from Evonik Industries AG)

### EXAMPLE 1

### Ethylphosphonous Acid

At room temperature, a three-neck flask with stirrer and jacketed coil condenser is initially charged with 188 g of water and degassed while stirring and passing nitrogen through. Then, under nitrogen, 0.2 mg of palladium(II) sulfate and 2.3 mg of tris(3-sulfophenyl)phosphine trisodium salt are added and the mixture is stirred, then 66 g of phosphinic acid in 66 g of water are added. The reaction solution is transferred to a 2 l Büchi reactor and, while stirring and under pressure, contacted with ethylene, and the reaction mixture is heated to 80° C. After 28 g have been absorbed, the mixture is cooled and free ethylene is discharged.

The reaction mixture is freed of the solvent on a rotary evaporator. The residue is admixed with 100 g of demineralized water and stirred at room temperature under a nitrogen atmosphere, then the mixture is filtered and the filtrate is extracted with toluene, then freed of the solvent on a rotary evaporator, and the resulting ethylphosphonous acid (92 g (98% of theory)) is collected.

### EXAMPLES 2-14

### Alkylphosphonous Acids, Salts, Esters

As in example 1, phosphinic acid sources (P) and olefins (O) are converted in the presence of transition metal (T) and ligands (L) in a solvent (S). The exact conditions and yields are listed in tables 1-2.

TABLE 1

| Ex- | | | | | | | Transition | | | | | Pres- | | | |
|---|---|---|---|---|---|---|---|---|---|---|---|---|---|---|---|
| am- | P source | | Solvent | | Olefin | | metal | | Ligand | | Temp. | sure | Time | Yield | |
| ple | (P) | [g] | (S) | [g] | (O) | [g] | (T) | [mg] | (L) | [mg] | [° C.] | [bar] | [h] | [g] | [%] |
| 2 | P1 | 198 | S1 | 6050 | O1 | 42.0 | T1 | 70.0 | L1 | 95.0 | 80 | 2.5 | 6 | 132.5 | 50.0 |
| 3 | P1 | 198 | S1 | 563 | O2 | 252.0 | T1 | 1.4 | L1 | 1.9 | 80 | 1.0 | 6 | 418.5 | 93.0 |
| 4 | P1 | 198 | S3 | 563 | O3 | 168.0 | T1 | 1.4 | L1 | 1.9 | 80 | 1.0 | 6 | 362.3 | 99.0 |
| 5 | P1 | 198 | S5 | 563 | O1 | 84.0 | T2 | 3.2 | L5 | 1.6 | 80 | 2.5 | 6 | 186.1 | 66.0 |
| 6 | P1 | 198 | S3 | 563 | O1 | 172.0 | T1 | 0.6 | L6 | 2.0 | 90 | 2.0 | 6 | 259.4 | 92.0 |
| 7 | P1 | 198 | S4 | 563 | O1 | 126.0 | T3 | 3.7 | L4 | 2.1 | 85 | 2.5 | 6 | 172.0 | 61.0 |
| 8 | P1 | 198 | S1 | 563 | O1 | 126.0 | T4 | 11.7 | L3 | 2.4 | 95 | 2.5 | 6 | 152.3 | 54.0 |
| 9 | P1 | 198 | S4 | 563 | O1 | 84.0 | T5 | 0.4 | L1 | 1.7 | 85 | 3.0 | 6 | 245.3 | 87.0 |
| 10 | P1 | 198 | S5 | 563 | O1 | 84.0 | T6 | 3.3 | L2 | 1.7 | 85 | 3.0 | 6 | 265.1 | 94.0 |
| 11 | P2 | 198 | S2 | 563 | O1 | 63.0 | T1 | 0.9 | L1 | 1.2 | 80 | 2.5 | 6 | 255.3 | 98.0 |
| 12 | P3 | 198 | S3 | 563 | O1 | 46.0 | T1 | 0.7 | L1 | 0.9 | 80 | 1.0 | 6 | 241.0 | 99.0 |
| 13 | P4 | 198 | S1 | 563 | O1 | 70.0 | T1 | 1.1 | L1 | 1.5 | 80 | 2.5 | 6 | 254.2 | 96.0 |

TABLE 2

| P source (P) | | Solvent (S) | | Olefin (O) | | Transition metal (T) | | Ligand (L) | |
|---|---|---|---|---|---|---|---|---|---|
| P1 | phosphinic acid | S1 | water/tetra- | O1 | ethylene | T1 | tris(dibenzylidene- | L1 | 4,5-bis(diphenyl- |
| | | | hydrofuran | | | | acetone)dipalladium | | phosphino)-9,9- |
| | | | | | | | | | dimethylxanthene |
| P2 | phosphinic acid | S2 | acetic acid | O2 | hexene | T2 | palladium on | L2 | 1,1′-bis(diphenyl- |
| | sodium salt | | | | | | carbon | | phosphino)ferrocene |
| P3 | butyl | S3 | butanol | O3 | butene | T3 | tetrakis(triphenyl- | L3 | 1,2-bis(diphenyl- |
| | phosphinate | | | | | | phosphine)platinum | | phosphino)ethane |
| P4 | phosphinic acid | S4 | tetrahydrofuran | O4 | styrene | T4 | platinum on | L4 | (R)-(+)-2,2′- |
| | ammonium salt | | | | | | alumina | | bis(diphenylphosphino)- |
| | | | | | | | | | 1,1′-binaphthalene |
| | | S5 | acetonitrile | | | T5 | nickel dichloride | L5 | triphenylphosphine |
| | | | | | | T6 | tetrakis(triphenyl- | L6 | triphenylphosphine |
| | | | | | | | phosphine)nickel | | bound on polystyrene |

TABLE 3

| Example | Product |
|---|---|
| 2, 5-10 | ethylphosphonous acid |
| 3 | 1-hexylphosphonous acid |
| 4 | 1-butylphosphonous acid |
| 11 | ethylphosphonous acid sodium salt |
| 12 | butyl ethylphosphonite |
| 13 | ethylphosphonous acid ammonium salt |

### EXAMPLE 14

### Phenylethylphosphonous Acid

As in example 1, 99 g of phosphinic acid, 563 g of acetonitrile, 167 g of styrene, 70.0 mg of tris(dibenzylideneacetone)dipalladium, 97.0 mg of 4,5-bis(diphenylphosphino)-9,9-dimethylxanthene, 9.0 mg of diphenylphosphinic acid are reacted, then purified by being passed through a column charged with Deloxan® THP II. The reaction mixture is freed of the solvent on a rotary evaporator. The residue is taken up in 500 ml of toluene and extracted twice with demineralized water. Thereafter, the mixture is freed of the solvent on a rotary evaporator. This gives 335 g (92% of theory) of a 2:1 mixture of 1-phenylethyl- and 2-phenylethylphosphonous acid.

### EXAMPLE 15

### Butyl Ethylphosphonite

As in example 1, 99 g of phosphinic acid, 396 g of butanol, 42 g of ethylene, 6.9 mg of tris(dibenzylideneacetone)dipalladium, 9.5 mg of 4,5-bis(diphenylphosphino)-9,9-dimethylxanthene are reacted, then purified by being passed through a column charged with Deloxan® THP II, and then n-butanol is added once again. At a reaction temperature of 80-110° C., the water formed is removed by azeotropic distillation. The product (butyl ethylphosphonite) is purified by distillation under reduced pressure. Yield: 189 g (84% of theory).

### EXAMPLE 16

### Butyl Ethylphosphonite

As in example 1, 198 g of phosphinic acid, 198 g of water, 84 g of ethylene, 6.1 mg of palladium(II) sulfate, 25.8 mg of 9,9-dimethyl-4,5-bis(diphenylphosphino)-2,7-sulfonatoxanthene sodium salt are reacted, then purified by being passed through a column charged with Deloxan® THP II, and then n-butanol is added. At a reaction temperature of 80-140° C., the water formed is removed by azeotropic distillation. The product is purified by distillation under reduced pressure. This gives 374 g (83% of theory) of butyl ethylphosphonite.

### EXAMPLE 17

### Ethylphosphonous Acid

150 g (1 mol) of butyl ethylphosphonite (prepared as in example 15) are admixed with 200 g of water and, at a reaction temperature of 110-150° C., the butanol formed is removed by azeotropic distillation. After removal of the water, 93 g (99% of theory) of ethylphosphonous acid are thus obtained.

### EXAMPLE 18

### Ethylphosphonous Acid Aluminum(III) Salt

564 g (6 mol) of ethylphosphonous acid (prepared as in example 1) are dissolved in 860 g of water and initially charged in a 5 l five-neck flask with thermometer, reflux condenser, high-intensity stirrer and dropping funnel, and neutralized with approx. 480 g (6 mol) of 50% sodium hydroxide solution. At about 90° C., a mixture of 1291 g of a 46% aqueous solution of Al₂(SO₄)₃.14 H₂O is added. Subsequently, the resulting solid is filtered off, washed with hot water and dried at 110° C. under reduced pressure. Yield: 502 g (82% of theory) of ethylphosphonous acid aluminum(III) salt as a colorless salt.

### EXAMPLE 19

### Butylphosphonous Acid Aluminum(III) Salt

1709 g (14 mol) of butylphosphonous acid (prepared as in example 4) are dissolved in 1.5 kg of water and initially charged in a 5 l five-neck flask with thermometer, reflux condenser, high-intensity stirrer and dropping funnel, and neutralized with approx. 1120 g (14 mol) of 50% sodium hydroxide solution. At about 90° C., 746 g (4.67 mol of aluminum) of aluminum acetate in 2254 g of water are added. Subsequently, the resulting solid is filtered off, washed with 2 l of hot water and dried at 110° C. under reduced pressure. Yield: 1530 g (84% of theory) of butylphosphonous acid aluminum(III) salt as a colorless salt.

### EXAMPLE 20

### Phenylethylphosphonous Acid Aluminum(III) Salt

2382 g (14 mol) of the mixture of 1-phenylethyl- and 2-phenylethylphosphonous acid (prepared as in example 14) are dissolved in 3.0 kg of water and initially charged in a 5 l five-neck flask with thermometer, reflux condenser, high-intensity stirrer and dropping funnel, and neutralized with approx. 1120 g (14 mol) of 50% sodium hydroxide solution. At about 90° C., 650 g (4.67 mol of aluminum) of aluminum chloride hexahydrate in 2350 g of water are added. Subsequently, the resulting solid is filtered off, washed with 2 l of hot water and dried at 110° C. under reduced pressure. Yield: 2120 g (85% of theory) of phenylethylphosphonous acid aluminum(III) salt as a colorless salt.

### EXAMPLE 21

### Ethylphosphonous Acid Aluminum(III) Salt

1316 g (14 mol) of ethylphosphonous acid (prepared as in example 1) are dissolved in 1.5 kg of water and initially charged in a 5 l five-neck flask with thermometer, reflux condenser, high-intensity stirrer and dropping funnel, and neutralized with approx. 1120 g (14 mol) of 50% sodium hydroxide solution. At about 90° C., 1725 g (4.67 mol of aluminum) of aluminum nitrate nonahydrate dissolved in 1275 g of water are added. Subsequently, the resulting solid is filtered off, washed with 2 l of hot water and dried at 110° C. under reduced pressure. Yield: 1091 g (76% of theory) of ethyiphosphonous acid aiuminum(III) salt as a colorless salt.

### EXAMPLE 22

### Ethylphosphonous Acid Aluminum(III) Salt

1316 g (14 mol) of ethylphosphonous acid (prepared as in example 1) are dissolved in 1.5 kg of water and initially charged in a 5 l five-neck flask with thermometer, reflux condenser, high-intensity stirrer and dropping funnel, and, at about 90° C., approx. 364 g (4.67 mol) of aluminum hydroxide are added and the mixture is heated in a closed reactor for 8 h at 150° C. After cooling to ambient temperature, the resulting solid is filtered off, washed with 2 l of hot water and dried at 110° C. under reduced pressure. Yield: 1007 g (71% of theory) of ethylphosphonous acid aluminum(III) salt as a colorless salt.

### EXAMPLE 23

### Ethylphosphonous Acid Titanium Salt

94 g (1 mol) of ethylphosphonous acid (prepared as in example 16) and 85 g of titanium tetrabutoxide are heated under reflux in 500 ml of toluene for 40 hours. Butanol formed is distilled off from time to time, together with portions of toluene. The solution formed is subsequently freed of the solvent. This gives 104 g (99% of theory) of ethylphosphonous acid titanium salt.

### EXAMPLE 24

### Ethylphosphonous Acid Zinc(II) Salt

1316 g (14 mol) of ethylphosphonous acid (prepared as in example 1) are dissolved in 1.5 kg of water and initially charged in a 5 l five-neck flask with thermometer, reflux condenser, high-intensity stirrer and dropping funnel, and neutralized with approx. 1120 g (14 mol) of 50% sodium hydroxide solution. At about 70° C., a solution of 2013 g of ZnSO₄*7H₂O (7 mol) in 2.5 kg of water is metered in. After 30 minutes, the resulting solid is filtered off, washed with hot water and dried at 110° C. under reduced pressure. Yield: 1020 g (58% of theory) of ethylphosphonous acid zinc(II) salt.

### EXAMPLE 25

### Ethylphosphonous Acid Zinc(II) Salt

1316 g (14 mol) of ethylphosphonous acid (prepared as in example 1) are dissolved in 1.5 kg of acetic acid and admixed with 570 g (7 mol) of zinc oxide. The clear solution formed is subsequently freed of the solvent used. Yield: 1743 g (99% of theory) of ethylphosphonous acid zinc(II) salt.

The inventive alkylphosphonous salts are used as flame retardants in the examples which follow:

Components Used

Commercial Polymers (Pellets):

nylon-6,6 (N 6,6-GR): Ultramid® A27 (from BASF AG, Germany)

polybutylene terephthalate (PBT) Ultradur® B4500 (from BASF AG, Germany)

Vetrotex 983 EC 10 4.5 mm glass fibers (from Saint-Gobain-Vetrotex, Germany)

Vetrotex 952 EC 10 4.5 mm glass fibers (from Saint-Gobain-Vetrotex, Germany)

Flame Retardant (Component A):

aluminum salt of diethylphosphinic acid, referred to here as DEPAL

Flame Retardant (Component B): aluminum salt of ethylphosphonous acid, referred to here as EPAL

Synergist (Component C):

melamine polyphosphate (referred to as MPP), Melapur® 200 (from Ciba SC, Switzerland)

melamine cyanurate (referred to as MC), Melapur® MC50 (from Ciba SC, Switzerland)

melem, Delacal® 420 (from Delamin Ltd, UK)

Component D:

zinc borate, Firebrake® ZB and Firebrake® 500, from. Borax, USA dihydrotalcite, DHT 4A, from Kyowa Chemicals, Japan

Phosphonites (Component E):

Sandostab® P-EPQ®, from Clariant, Germany

Wax Components (Component F):

Licomont® CaV 102, Clariant, Germany (calcium salt of montan wax acid)

Licowax® E, from Clariant, Germany (ester of montan wax acid)

Production, Processing and Testing of Flame-Retardant Polymer Molding Compositions:

The flame retardant components were mixed with the phosphonite, the lubricants and stabilizers in the ratio specified in the table and incorporated via the side intake of a twin-screw extruder (Leistritz ZSE 27/44D) into N 6,6 at temperatures of 260 to 310° C., and into PBT at 250-275° C. The glass fibers were added via a second side intake. The homogenized polymer strand was drawn off, cooled in a water bath and then pelletized.

After sufficient drying, the molding compositions were processed to test specimens on an injection molding machine (Arburg 320 C Allrounder) at melt temperatures of 250 to 300° C., and tested and classified for flame retardancy using the UL 94 test (Underwriter Laboratories).

The flowability of the molding compositions was determined by finding the melt volume flow rate (MVR) at 275° C./2.16 kg. A sharp rise in the MVR value indicates polymer degradation.

All tests in the respective series, unless stated otherwise, were performed under identical conditions (temperature programs, screw geometry, injection molding parameters, etc.) due to comparability.

Formulations C-1 to C-3 are comparative examples in which a flame retardant combination based on the aluminum salt of diethylphosphinic acid (DEPAL) and the nitrogen-containing synergist melamine polyphosphate (MPP) and the metal oxide or borate alone were used.

The results in which the flame retardant-stabilizer mixture according to the invention was used are listed in examples I-1 to I-4. All amounts are reported as % by weight and are based on the polymer molding composition including the flame retardant mixture and additives.

TABLE 4
N 66 GF 30 test results.

| | C-1 | C-2 | C-3 | I-1 | I-2 | I-3 | I-4 |
|---|---|---|---|---|---|---|---|
| nylon-6,6 | 49.55 | 49.55 | 49.55 | 49.55 | 49.55 | 49.55 | 49.55 |
| 983 glass | 30 | 30 | 30 | 30 | 30 | 30 | 30 |
| fibers | | | | | | | |
| A: DEPAL | 13 | 12 | 12 | 12 | 12 | 12 | 15 |
| B: EPAL | | | | 5 | 4 | 4 | 5 |
| C: MPP | 7 | 7 | 7 | 3 | 3 | 3 | |
| D1: zinc | | 1 | | | 1 | | |
| borate | | | | | | | |
| D2: DHT4A | | | 1 | | | 1 | |
| E: CaV 102 | 0.25 | 0.25 | 0.25 | 0.25 | 0.25 | 0.25 | 0.25 |
| F: P-EPQ | 0.20 | 0.20 | 0.20 | 0.20 | 0.20 | 0.20 | 0.20 |
| UL 94 | V-0 | V-0 | V-1 | V-0 | V-0 | V-0 | V-0 |
| 0.8 mm | | | | | | | |
| MVR | 19 | 12 | 14 | 5 | 3 | 4 | 3 |
| 275° C./ | | | | | | | |
| 2.16 kg | | | | | | | |
| Exuda- | se- | marked | marked | low | none | low | none |
| tion* | vere | | | | | | |
| Color | gray | white | white | white | white | white | white |
| Impact resis- | 61 | 61 | 55 | 61 | 63 | 66 | 61 |
| tance [kJ/m²] | | | | | | | |
| Notched | 15 | 16 | 12 | 9.4 | 15 | 11 | 15 |
| impact resis- | | | | | | | |
| tance [kJ/m²] | | | | | | | |

*14 days, 100% humidity, 70° C.

It is clear from the examples that the inventive mixtures of the DEPAL, EPAL and optionally MPP and borate or hydrotalcite components and components E and F clearly improve the processibility of the polymers and the properties of the injection moldings, without impairing flame retardancy.

The incorporation of the DEPAL and MPP flame retardants into N 6,6 does lead to UL 94 V-0, but also to gray discoloration of the molding compositions, exudation and high melt indices (C-1). The addition of zinc borate or hydrotalcite can prevent the gray discoloration, and exudation declines markedly (C-2, C-3).

If an inventive flame retardant combination of DEPAL, EPAL and optionally nitrogen synergist, borate or hydrotalcite lubricant and stabilizer (I1-I4) is then used, the result is not only flame retardancy but also no discoloration, no exudation, low melt indices and good mechanical properties. The low melt index (MVR) shows that there is no polymer degradation.

TABLE 5
PBT GF 25 test results.

| | C-4 | C-5 | C-6 | I-5 | I-6 | I-7 | I-8 |
|---|---|---|---|---|---|---|---|
| PBT | 49.55 | 49.55 | 49.55 | 49.55 | 49.55 | 49.55 | 49.55 |
| 952 | 25 | 25 | 25 | 25 | 25 | 25 | 25 |
| glass | | | | | | | |
| fibers | | | | | | | |
| A: | 13.3 | 12 | 12 | 12 | 12 | 12 | 15 |
| DEPAL | | | | | | | |
| B: | | | | 5 | 4 | 4 | 5 |
| EPAL | | | | | | | |
| C1: MC | 7 | 7 | 7 | 3 | 3 | 3 | |
| C2: | | 1 | | | 1 | | |
| MPP | | | | | | | |
| C3: | | | 1 | | | 1 | |
| melem | | | | | | | |
| E: Lico- | 0.25 | 0.25 | 0.25 | 0.25 | 0.25 | 0.25 | 0.25 |
| wax E | | | | | | | |
| F: | 0.20 | 0.20 | 0.20 | 0.20 | 0.20 | 0.20 | 0.20 |
| P-EPQ | | | | | | | |
| UL 94 | V-1 | V-1 | V-1 | V-0 | V-0 | V-0 | V-0 |
| 0.8 mm | | | | | | | |
| Solu- | 1185 | 1201 | 1179 | 1375 | 1364 | 1338 | 1399 |
| tion | | | | | | | |
| viscos- | | | | | | | |
| ity SV* | | | | | | | |
| Elonga- | 2.1 | 2.2 | 2.1 | 2.4 | 2.4 | 2.4 | 2.2 |
| tion at | | | | | | | |
| break | | | | | | | |
| [%] | | | | | | | |
| Impact | 40 | 41 | 39 | 49 | 48 | 47 | 47 |
| resis- | | | | | | | |
| tance | | | | | | | |
| [kJ/m²] | | | | | | | |
| Notched | 6.3 | 6.6 | 6.2 | 7.8 | 7.5 | 7.6 | 7.5 |
| impact | | | | | | | |
| resis- | | | | | | | |
| tance | | | | | | | |
| [kJ/m²] | | | | | | | |

*in dichloroacetic acid, pure PBT (uncompounded) gives 1450

The incorporation of DEPAL and MC and the further additives (examples C-4-6) leads only to a V-1 classification and distinct polymer degradation, evident from the low solution viscosities. The mechanical values are also low compared to non-flame-retardant PBT. The inventive combination of DEPAL with EPAL and optionally the further additives virtually completely suppresses polymer degradation; fire class V-0 is attained and the mechanical values are improved.

### EXAMPLE 27

In the case of unsaturated polyester resins (UP) and the epoxy resins (EP), a reinforcing material, for example a continuous glass textile mat of basis weight 200 g/m², is impregnated with a homogenized mixture (UP 1, UP 2, EP 1, EP 2) of resin, accelerator, the flame retardant component(s), hardener and possibly solvent, hardened at room temperature for 24 hours and heat-treated at 80° C. for an additional 3 hours.

UP 1:

100 parts Palatal® A 400-01 unsaturated polyester resin, 0.5 part NL-49 P, 70 parts EPAL, 2 parts Butanox M-50.

UP 2:

100 parts Palatal® A 400-01 unsaturated polyester resin, 0.5 part NL-49 P, 17.5 parts EPAL, 52.5 parts DEPAL, 2 parts Butanox M-50.

EP 1:

100 parts Beckopox EP 140, 41 parts Beckopox EH 628, 30 parts EPAL

EP 2:

100 parts Beckopox EP 140, 41 parts Beckopox EH 628, 7.5 parts EPAL, 22.5 parts DEPAL

The fire performance was tested by the Underwriters Laboratories method “Test for Flammability of Plastics Materials—UL 94” in the version dated May 2, 1975 on test specimens of above-described laminates of length 127 mm, width 12.7 mm and thickness 1.6 mm.

The laminates obtained from mixtures UP 1, UP 2, EP 1 and EP 2 have a UL-94 classification which was determined to be V-0.

1. A process for preparing alkylphosphonous salt, comprising the steps of:
a) reacting a phosphinic acid source (I) 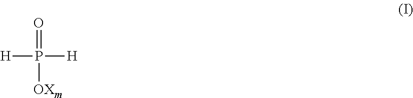
with olefins (IV) 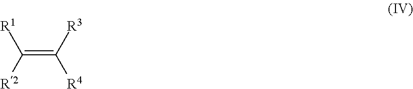
in the presence of a catalyst A to give an alkylphosphonous acid or salt or ester thereof (II) 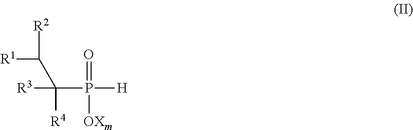
where R¹, R², R³, R⁴ are each independently H, C₁-C₁₈-alkyl, C₆-C₁₈-aryl, C₇-C₁₆-arylalkyl, C₇-C₁₈-alkylaryl and X is H, C₁-C₁₈-alkyl, C₆-C₁₈-aryl, C₇-C₁₈-arylalkyl, C₇-C₁₈-alkylaryl, C₂-C₁₈-alkenyl, (CH₂)ₖOH, CH₂—CHOH—CH₂OH, —(CH₂—CH₂O)ₖH or (CH₂—CH₂O)ₖ-alkyl, where k is an integer from 0 to 10, and/or X is H, Mg, Ca, Ba, Al, Pb, Fe, Zn, Mn, Ni, Li, Na, K and/or a protonated nitrogen base, where m is ⅓, ½, 1, and the catalyst A comprises transition metals and/or transition metal compounds and/or catalyst systems composed of a transition metal and/or a transition metal compound and at least one ligand, and
b) reacting the alkylphosphonous acid or salt or ester thereof (II) with metal compounds of Mg, Ca, Al, Sb, Sn, Ge, Ti, Fe, Zr, Zn, Ce, Bi, Sr, Mn, Li, Na, K, a protonated nitrogen base or a combination thereof to give the corresponding alkylphosphonous salts (III) of these metals a nitrogen compound or a combination thereof 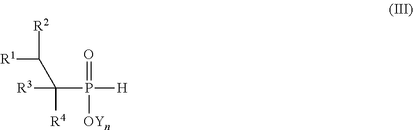
where R¹, R², R³, R⁴ are each as defined under a) and Y is Mg, Ca, Al, Sb, Sn, Ge, Ti, Fe, Zr, Zn, Ce, Bi, Sr, Mn, Li, Na, K a nitrogen compound or a combination thereof and n is ¼, ⅓, ½, 1.

2. The process as claimed in claim 1, wherein R¹, R², R³, R⁴ are the same or different and are each independently H, methyl, ethyl, n-propyl, isopropyl, n-butyl, isobutyl, tert-butyl, phenyl or a combination thereof.

3. The process as claimed in claim 1, wherein the olefins (IV) are ethylene, propylene, n-butene, styrene or a combination thereof.

4. The process as claimed in claim 1, wherein the phosphinic acid source (I) is phosphinic acid, or the sodium, potassium, calcium, magnesium, aluminum, ammonium salt, a methyl, ethyl, propyl, i-propyl, butyl, t-butyl, glycol ester thereof or a combination thereof.

5. The process as claimed in claim 1, wherein the transition metals, the transition metal compounds or both are those from the seventh and eighth transition groups.

6. The process as claimed in claim 1, wherein the transition metals, the transition metal compounds or both are rhodium, nickel, palladium, ruthenium and/or platinum.

7. The process as claimed in claim 1, wherein the alkylphosphonous salts (III) are aluminum(III), calcium(II), magnesium(II), cerium(III), Ti(IV) and/or zinc(II) salts of ethyl-, propyl-, i-propyl-, butyl-, sec-butyl-, i-butyl-, 1-phenylethyl- 2-phenylethylphosphonous acid or a combination thereof.

8. The process as claimed in claim 1, wherein the inventive alkylphosphonous salts obtained, based on the total weight of the mixture, comprises 0 to 5% by weight of alkylphosphonic salts, dialkylphosphinic salts or a combination thereof.

9. An alkylphosphonous acid-flame retardant combination comprising 0.5 to 99.5% by weight of alkylphosphonous salt (III) according to claims 1 and 0.5 to 99.5% by weight of at least one further flame retardant.

10. The alkylphosphonous acid-flame retardant combination as claimed in claim 9, wherein the at least one further flame retardants are dialkylphosphinic salts, aryl phosphates, phosphonates, salts of hypophosphorous acid and red phosphorus, brominated aromatic or cycloaliphatic hydrocarbons, phenols or ethers, chloroparaffin, hexachlorocyclopentadiene adducts or a combination thereof.

11. The an alkylphosphonous acid-flame retardant combination as claimed in claim 9, wherein the alkylphosphonous acid-flame retardant combination comprises 0.5 to 30% by weight of ethylphosphonous acid aluminum salt and 70 to 99.5% by weight of diethylphosphinic acid aluminum salt.

12. A flame retardant or an intermediate for preparation of flame retardants for thermoplastic polymers, for thermoset polymers, for clearcoats, for intumescent coatings, for wood and other cellulosic products, for production of flame-retardant polymer molding compositions, for production of flame-retardant polymer moldings and/or for rendering pure and blended polyester and cellulose fabrics flame-retardant by impregnation comprising a flame retardant combination as claimed in claim 9.

13. The flame retardant or an intermediate as claimed in claim 12, wherein the thermoplastic polymers are polyester, polystyrene, polyamide or a combination thereof, and the thermoset polymers are unsaturated polyester resins, epoxy resins, polyurethanes, acrylates or a combination thereof.

14. A flame-retardant thermoplastic or thermoset polymer molding composition comprising 2 to 50% by weight of at least one alkylphosphonous salt (III) prepared according to the process of claim 1, based on the thermoplastic or thermoset polymer.

15. A flame-retardant thermoplastic or thermoset polymer molding, film, filament or fiber comprising 2 to 50% by weight of at least one alkylphosphonous salt (III) prepared according to the process of claim 1, based on the thermoplastic or thermoset polymer.

16. A flame-retardant thermoplastic or thermoset polymer molding, film, filament or fiber comprising 3 to 40% by weight of at least one alkylphosphonous salt (III) prepared according to the process of claim 1, based on the thermoplastic or thermoset polymer.

17. An alkylphosphonous salt-flame retardant combination as claimed in claim 9, based on the thermoplastic or thermoset polymer.

18. A flame retardant or an intermediate for preparation of flame retardants for thermoplastic polymers, for thermoset polymers, for clearcoats, for intumescent coatings, for wood and other cellulosic products, for production of flame-retardant polymer molding compositions, for production of flame-retardant polymer moldings and/or for rendering pure and blended polyester and cellulose fabrics flame-retardant by impregnation comprising at least one alkylphosphonous salt (III) prepared according to the process of claim 1.

19. A flame-retardant thermoplastic or thermoset polymer molding, film, filament or fiber comprising 3 to 40% by weight of an alkylphosphonous salt-flame retardant combination as claimed in claim 9, based on the thermoplastic or thermoset polymer.
